(19) United States
(12) Patent Application Publication
(10) Pub. No.: US 2026/0343716 A1
(43) Pub. Date: Oct. 29, 2026

(54) Electrostatic Discharge Apparatus

(71) Applicant: William Robert Haller, BETHLEHEM, PA (US)

(72) Inventor: William Robert Haller, BETHLEHEM, PA (US)

(21) Appl. No.: 19/660,713

(22) Filed: Apr. 28, 2026

Related U.S. Application Data
(60) Provisional application No. 63/796,682, filed on Apr. 29, 2025.

(51) Int. Cl. H05F 3/02

(52) U.S. Cl. CPC H05F 3/02

(57) ABSTRACT

An electrostatic discharge apparatus is provided comprising a conductor, a ground connection, a dissipative element, a sensor, a controller, and an indicator. The conductor may be configured for interaction with a user. The dissipative element may be electrically coupled between the conductor and the ground connection to dissipate electrostatic charge. The sensor may be configured to detect the user interaction with the conductor. The controller may be responsive to the sensor and configured to generate a time-delayed response based on the detected interaction. The indicator may be responsive to the time-delayed response to prompt discharge of electrostatic charge through the conductor. The time-delayed response may be programmable by the user or automatically programmed based on the relative humidity.

### CROSS REFERENCE TO RELATED APPLICATIONS

This application claims priority to U.S. Provisional Patent Application No. 63/796,682 filed Apr. 29, 2025. This prior application is incorporated by reference into this document, in its entirety and for all purposes.

### STATEMENT OF FEDERALLY SPONSORED RESEARCH

This invention was made without government support, and the government has no rights to this invention.

### FIELD OF THE INVENTION

The present invention generally relates to an electrostatic discharge apparatus for dissipating electrostatic charge from a user to a ground connection in a safe and controlled manner, and more particularly, to an electrostatic discharge apparatus configured to provide discharge reminders.

### BACKGROUND OF THE INVENTION

It is well known that electrostatic charge may be created during normal human activity including walking across a carpet or sliding across a car seat. The most common way to generate electrostatic charges is typically through friction by rubbing or sliding a first material against a second material.

Upon separation of the first material from the second material, electron transfer may occur resulting in the first material gaining a positive charge and the second material gaining a negative charge or vice versa.

The static charge generation attributed to frictional contact and subsequent separation between the two materials is commonly known as the triboelectric effect. The static charge attributed to the triboelectric effect may have positive or negative polarity and may accumulate in sufficient quantity to produce a high voltage which may exceed 30,000 volts. A person may experience an accumulation of charge by simply walking across a carpet or sliding on top of an office chair.

As an electrostatically charged person approaches a grounded conductive object, the high voltage may ionize the air between the charged person and the grounded conductive object causing an almost instantaneous discharge and neutralization of the accumulated electrostatic charge.

The occurrence of the electrostatic discharge is commonly referred to as an electrostatic discharge event. During the electrostatic discharge event, a flow of charge may then occur from the charged person to an oppositely charge object thereby neutralizing any accumulated charge. Conversely, a flow of charge may occur from the object to the charged person.

The ionization of the air and the subsequent flow of charge may result in a spark between the electrostatically charged person and the grounded object and, depending upon amount of accumulated charge, may cause a painful sensation to the person. Additionally, the current which flows during the electrostatic discharge event may exceed many amperes but has a very short duration. The electrostatic discharge event may also produce radio frequency interference.

It is well known in the electronics industry that electrostatic discharge events may be very harmful to electronic circuits, particularly circuits which use metal oxide semiconductor field effect transistors (MOSFETS) and other semiconductor devices. Minimizing the severity and frequency of electrostatic discharge events would greatly increase the reliability of electronic circuits, particularly semiconductor circuits. Controlling or eliminating electrostatic discharge events during the manufacture, repair and operation of semiconductor circuits is very desirable for maintaining proper circuit operation.

In an attempt to minimize or eliminate the severity and frequency of electrostatic discharge events, many different solutions have been proposed in the art which include wrist straps, electrostatic discharge pads, air ionizers, static reducing sprays and humidifiers to name a few. Although successful in mitigating the severity and frequency of harmful electrostatic discharge events, there are a number of disadvantages in using these devices in the workplace.

For example, a wrist strap requires a conductive band be wrapped around the wrist having a wire from the band attached to a ground connection to bleed off any accumulated charge. The far end of the wire usually has a mechanical means such as an alligator clip for clipping or otherwise attaching the wire to a ground connection. The ground connection may include the earth ground connection of a residential 3-prong AC socket.

The wrist band and wire combination however may restrict the free movement of the person's arm, wrist and hand when attempting to perform manual tasks where the hands and arms need to be frequently moved, including typing on a computer keyboard or transitioning from a computer keyboard to a pointing device such as a mouse. Other situations requiring free movement of the person's arms and hands may include the construction and repair of electronic circuits, or inserting USB memory sticks into a computer which may be impeded by the attached wrist band and wire combination.

Another problem is the attachment of the alligator chip to a ground connection. This type of clip attachment has a tendency to become disconnected thereby not providing the necessary ground connection for bleeding off the accumulated electrostatic charge.

Additionally, most conventional wrist straps do not provide an indicator to alert the person of a disconnected ground connection. Without a proper ground connection, the accumulated static charge may not be properly dissipated and may still pose a threat to electronic circuits and other static sensitive devices.

As another example of attempting to mitigate the buildup of electrostatic charge, an electrostatic discharge pad provides a charge dissipative surface which is subsequently connected to a ground connection. The person must physically contact the dissipative surface of the electrostatic discharge pad to bleed off the accumulated electrostatic charge.

It is preferred that the location of the electrostatic discharge pad be chosen to allow frequent electrical contact between the person and the dissipative surface. The large footprint and location of the pad may prove intrusive especially on a desk top having limited space among a computer, one or more computer displays, a mouse and other computer related accessories.

Additionally, the electrostatic discharge pads may not provide an indicator for alerting the person if the ground connection has been disconnected, leaving the person to falsely believe that the discharge pad is dissipating electrostatic charge when in fact a non-grounded pad provides little if any electrostatic discharge benefit.

Further, electrostatic discharge pads are usually constructed from electrically conductive foam or plastic and may still produce a spark along with the subsequent painful sensation to the user. Additionally, electrostatic discharge pads are not easily portable.

Yet another example of attempting to mitigate the buildup of electrostatic charge is the use of air ionizers. Air ionizers are designed to create and disperse positive and negative charged ions into the air. The dispersed ions may then combine with the electrostatic charge of the opposite polarity neutralizing the electrostatic charge. Air ionizers may have a large physical footprint which makes them awkward to use on a desktop with limited space and are not easily portable.

Another example of attempting to mitigate the buildup of electrostatic charge is the use of static reducing sprays. The static reducing sprays tend to slightly increase the conductivity of surfaces which may provide a discharge path for electrostatic charge to bleed off to a ground connection.

However, static reducing sprays leave a conductive film on the sprayed surface which may be detrimental to the operation of computer keyboards and monitors, and other electronic devices, especially when attempting to repair or manufacture sensitive electronic equipment.

The conductive spray may also need to be reapplied over time to maintain its electrostatic dissipating properties. The repeated application of the conductive spray may result in an undesirable build-up of a residue sticky-like film over the treated surfaces.

Yet another example of attempting to mitigate the buildup of electrostatic charge is the use of an air humidifier to increase the relative humidity. It is well known that by artificially increasing the relative humidity with water vapor tends to provide a conductive path to bleed off any accumulated electrostatic charge. Relative humidity is a key factor in determining the likelihood of an electrostatic discharge event.

However, the water vapor produced by the humidifier may condense on electronic circuits increasing the surface conductivity of a printed circuit board and possibly causing a high impedance short circuit between electronic components.

Thus, there is a need in the electrostatic discharge industry for an electrostatic discharge apparatus having a small footprint which controllably dissipates electrostatic charge from the person and in which the electrostatic discharge apparatus is easily connected to ground.

There is also a need for an electrostatic discharge apparatus to dissipate electrostatic charge from the person to ground without the need for wrist bands, sprays, air ionizers or humidifiers.

There is also a need for an electrostatic discharge apparatus to alert the person when the ground connection has been disconnected.

There is yet another need for an electrostatic discharge apparatus to prompt the person to discharge the accumulated electrostatic charge.

There is also another need for an electrostatic discharge apparatus to display the relative humidity.

There is yet another need for an electrostatic discharge apparatus to prompt the person to dissipate electrostatic charge in response to the relative humidity.

There is also another need for an electrostatic discharge apparatus which attaches to a port of a computer or an alternating current to direct current (AC to DC) power converter thus providing a convenient ground connection without the need to separately connect a wire for bleeding off any accumulated electrostatic static charge.

There is yet another need for an electrostatic discharge apparatus to inform the person of the likelihood of an electrostatic discharge event occurring in response to the relative humidity.

There is also a need to provide an electrostatic discharge and monitoring system comprising a network of computers connected to the internet with each computer including an electrostatic discharge apparatus. The relative humidity and temperature data, the frequency of user interaction with the electrostatic discharge apparatus and other data may be made available to the network.

### BRIEF SUMMARY OF THE INVENTION

In an aspect, an electrostatic discharge apparatus is provided. The apparatus may include a conductor, a ground connection, a dissipative element, a sensor, a controller, and an indicator. The conductor may be configured for interaction with a user. The dissipative element may be electrically coupled between the conductor and the ground connection to dissipate electrostatic charge. The sensor may be configured to detect the user interaction with the conductor. The controller may be responsive to the sensor and configured to generate a time-delayed response based on the detected interaction. The indicator may be responsive to the time-delayed response to prompt discharge of electrostatic charge through the conductor.

### BRIEF DESCRIPTION OF THE DRAWING

The above and other aspects and advantages of the invention will become more apparent upon consideration of the following detailed description, taken in conjunction with accompanying drawing.

It is emphasized that, according to common practice, the various features of the drawing are not to scale. On the contrary, the dimensions of the various features are arbitrarily expanded or reduced for clarity, and in which reference characters refer to like parts throughout. Included in the drawing are the following figures:

FIG. 1 is a top perspective view of an electrostatic discharge apparatus in accordance with the embodiments of the present invention.

FIG. 2 is a top inside perspective view of the electrostatic discharge apparatus of FIG. 1 in accordance with the embodiments of the present invention having an upper member removed and illustrating a location of a first printed circuit board, a first and a second right-angle triangular prisms and a conductive pad having an exposed top surface.

FIG. 3 is a planar view of the bottom side of the electrostatic discharge apparatus of FIG. 1 in accordance with the embodiments of the present invention illustrating the location of a sound selector switch, a reset switch and a relative humidity and temperature access port.

FIG. 4 is a bottom inside perspective view of the electrostatic discharge apparatus of FIG. 1 in accordance with the embodiments of the present invention having a lower member removed and illustrating the location of the sound selector switch, an audible indicator and light emitting diode (LED) indicators, a reset switch and an electrostatic charge dissipative element positioned within a potting box.

FIG. 5 is a sectional view of the electrostatic discharge apparatus in accordance with the embodiments of the present invention indicated by the cutting plane line 5-5 as shown in FIG. 1.

FIG. 6 is a partial sectional view of the electrostatic discharge apparatus indicated by the cutting plane line 5-5 as shown in FIG. 1 in accordance with the embodiments of the present invention illustrating an optical path from an electromagnetic radiator, through a first right-angle triangular prism, across the surface of the conductive pad, through a second right-angle triangular prism, and to an electromagnetic detector.

FIG. 7 is a schematic diagram of a circuit of the electrostatic discharge apparatus in accordance with embodiments of the present invention.

FIG. 8A is a perspective front view of an AC to DC power converter for providing +5V DC supply voltage and a ground connection to the electrostatic discharge apparatus from a grounded 3-prong AC power socket in accordance with the embodiments of the present invention.

FIG. 8B is a planar rear view of the AC to DC converter illustrating a female USB connector for providing +5V DC supply voltage and a ground connection to the electrostatic discharge apparatus in accordance with the embodiments of the present invention.

FIG. 9A-9F is an operational flow chart of exemplary methods for practicing the present invention, in accordance with embodiments of the present invention.

FIG. 10 illustrates an output voltage vs. the relative humidity transfer function of an exemplary relative humidity and temperature sensor for practicing the present invention.

FIG. 11 illustrates a look-up table which lists the ranges of relative humidity values, and the corresponding values assigned to the t1 register, the t2 register and the RH_Level register based on the ranges in accordance with embodiments of the present invention.

FIG. 12 illustrates the relative humidity level and the corresponding LED color and the number of LED blinks of a relative humidity LED indicator for each RH_Level register value and relative humidity range in accordance with embodiments of the present invention.

FIG. 13 illustrates a timing diagram of the three operational states of the electrostatic discharge apparatus defined by the time intervals t1, t2 and t3 in accordance with embodiments of the present invention.

FIG. 14 illustrates an electrostatic discharge and monitoring system comprising a network of computers connected to the internet with each computer having a connected electrostatic discharge apparatus.

### DETAILED DESCRIPTION OF THE INVENTION

In the following description, several specific details are presented to provide a thorough understanding of the embodiments of the inventive concepts disclosed herein.

One skilled in the relevant art will recognize, however, that embodiments of the inventive concepts disclosed herein can be practiced without one or more of the specific details, or in combination with other components, etc. In other instances, well-known implementations or operations are not shown or described in detail to avoid obscuring aspects of various embodiments of the inventive concepts disclosed herein.

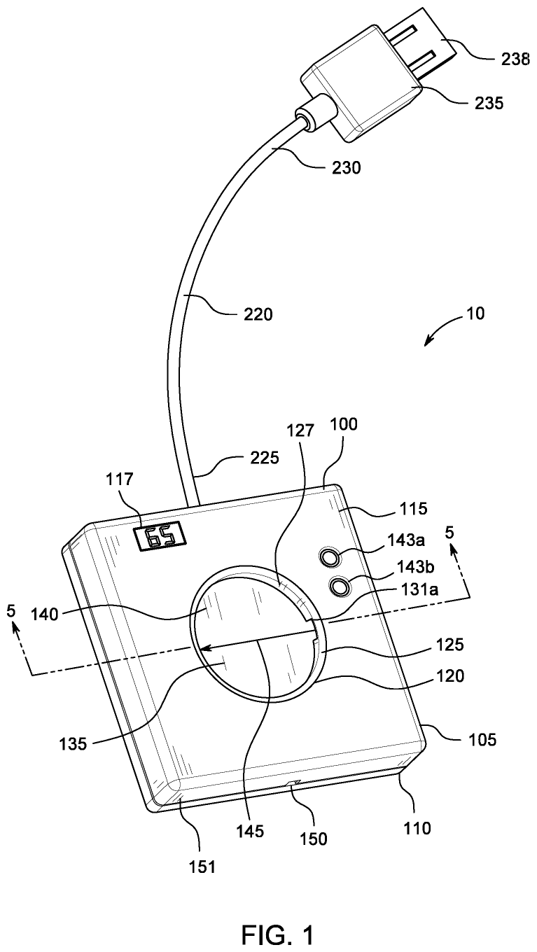

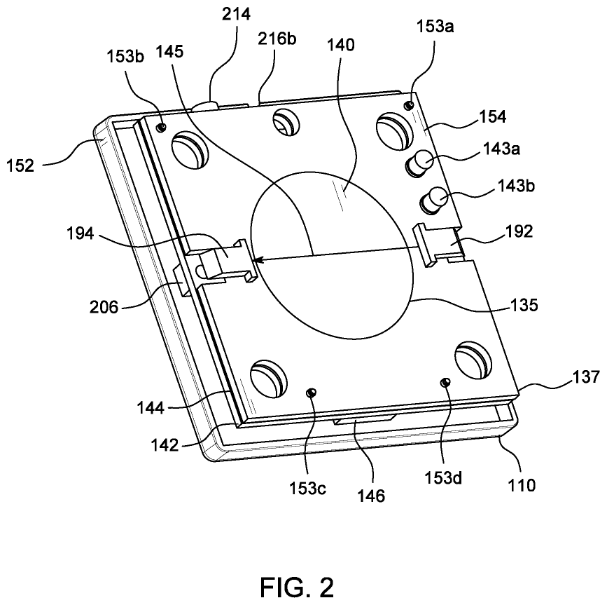

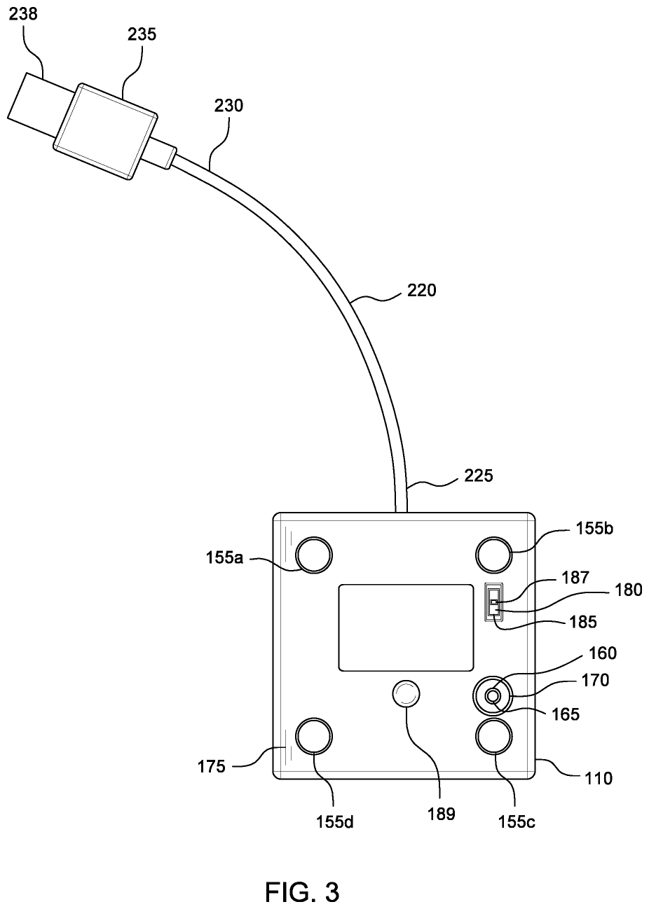

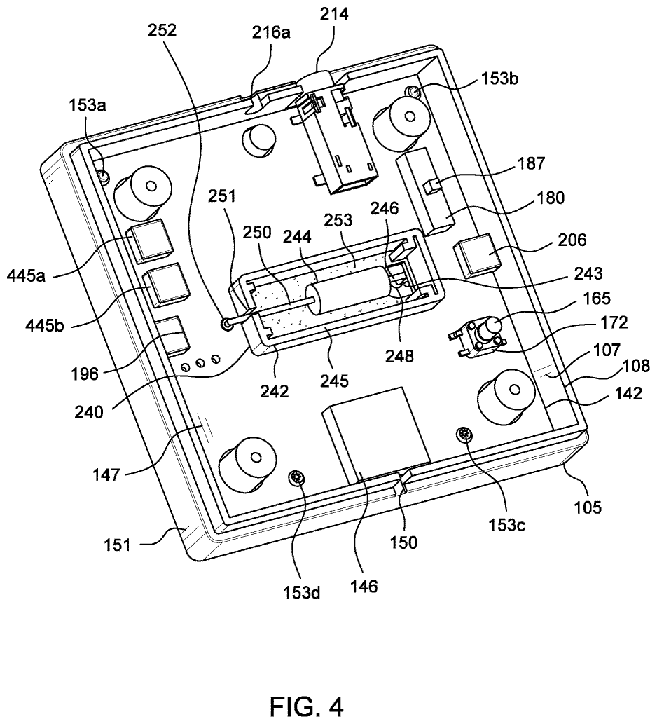

Referring to FIGS. 1-6 , an electrostatic discharge apparatus 10 in accordance with embodiments of the present invention is shown. The electrostatic discharge apparatus 10 comprises a rectangular housing 100. The rectangular housing 100 includes an upper member 105 and a lower member 110.

The upper member 105 includes a top surface 115, an inside surface 107 and a side wall 151. The inside surface 107 defines a cavity 108 within the upper member 105. The lower member 110 includes a side wall 152 and an outside bottom surface 175. The upper member 105 is affixed to the lower member 110 using fasteners (not shown) to form the rectangular housing 100.

It is understood that the housing 100 may have any geometrical shape, such as round or hexagonal shapes. The upper member 105 and the lower member 110 may comprise a plastic or other non-conductive material.

The side walls 151 and 152 include a first semicircular opening 216a and a second semicircular opening 216b, respectively. When the upper member 105 is affixed to the lower member 110, the first and second semicircular openings 216a and 216b are aligned and form an access hole into the interior of the housing 100.

A cable 220 provides a +5V DC supply voltage referenced to a power ground 301 and digital data communication signals to the electrostatic discharge apparatus 10. The cable 220 may include, but is not limited to, a Universal Serial Bus (USB) cable. The cable 220 includes a proximal end 225 and a distal end 230.

The proximal end 225 passes through the access hole formed by the closed semicircular openings 216a and 216b, and is affixed to housing 100 using a strain relief (not shown). The distal end 230 is fitted with a male connector 235. The male connector 235 includes a metallic shell 238. The male connector 235 may include, but is not limited to, a USB Type-A connector.

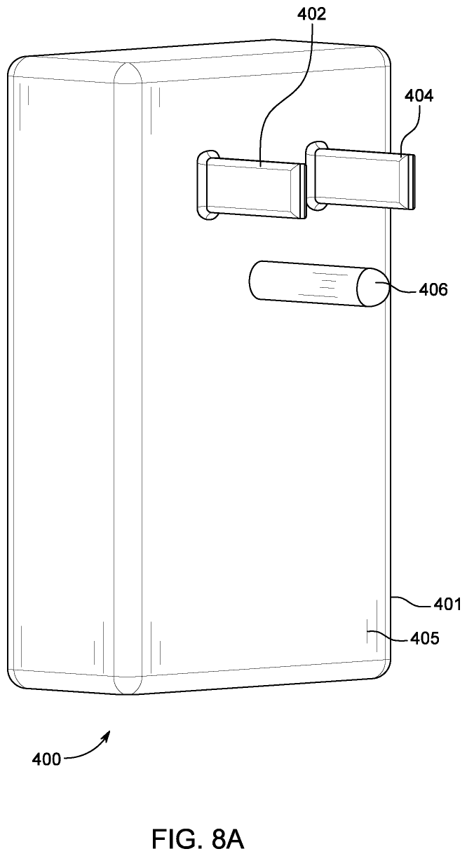

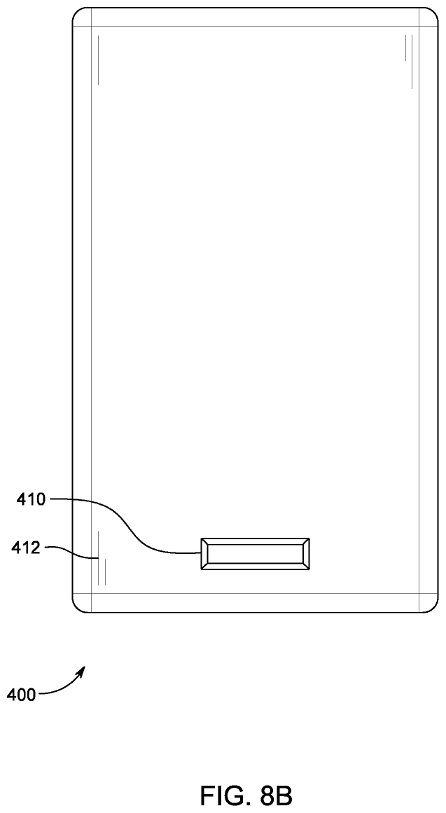

The male connector 235 may be configured to be inserted into a mating female connector, including, but not limited to, a female USB connector 410 of the AC to DC converter 400 (shown in FIG. 8B), or a female connector provided on an earth-grounded computer.

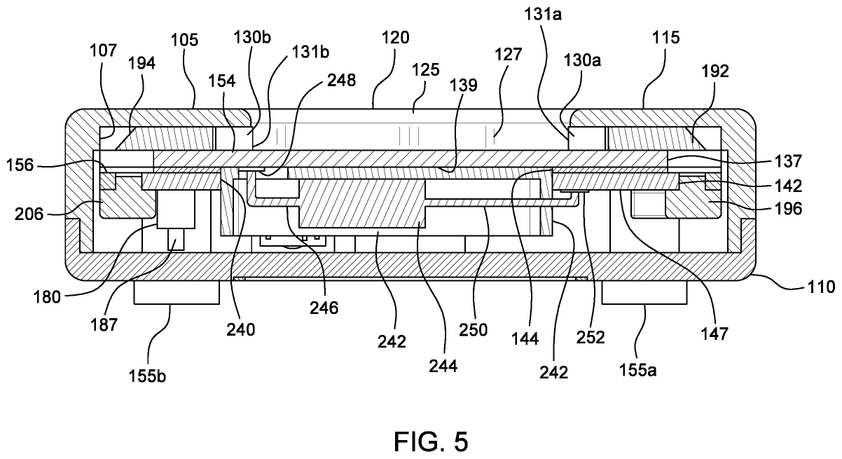

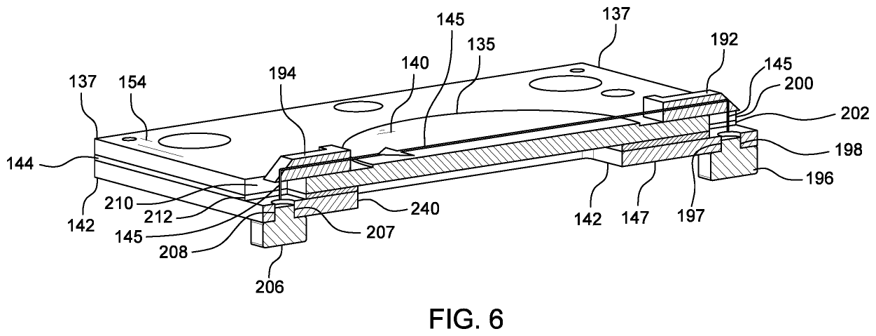

Shown in FIG. 1 is a cutting plane represented by line 5-5 and is used to create the sectional views shown in FIGS. 5 and 6.

Formed on the surface 115 is a circular opening 120 including a beveled edge 125 and a side wall 127. Further disposed on the surface 115 is an alphanumeric liquid crystal (LCD) display 117, a first light-emitting diode (LED) lens 143a, and a second light-emitting diode (LED) lens 143b.

A first printed first printed circuit board 137, an insulator 144, and a second printed circuit board 142 are disposed within the cavity 108. The first printed circuit board 137 includes a top surface 154 and a bottom surface 139. The second printed circuit board 142 includes a top surface 156 and a bottom surface 147. The insulator 144 may comprise a solid material, such as a sheet of polytetrafluoroethylene (PTFE) material (e.g., Teflon®).

The first printed circuit board 137, the insulator 144 (when solid), and the second printed circuit board 142 are stacked and fastened together to form a stacked assembly. The insulator 144 is disposed between and in contact with the first printed circuit board 137 and the second printed circuit board 142.

The stacked assembly may be collectively affixed to the inside surface 107 with fasteners, such as screws 153a-153d. The top surface 154 of the first printed circuit board 137 is substantially flush with the inside surface 107.

Alternatively, four round insulating plastic washers (not shown) disposed around and concentric with the screws 153a-153d may be positioned between the first printed circuit board 137 and the second printed circuit board 142 to define a first air gap between the first printed circuit board 137 and the second printed circuit board 142 in place of the insulator 144 when formed of a solid material.

The top surface 154 comprises a copper layer. The copper layer of the top surface 154 may be etched to define a circular conductive pad 135 configured for interaction with the user. The conductive pad 135 includes a top surface 140 and is sized to enable such interaction.

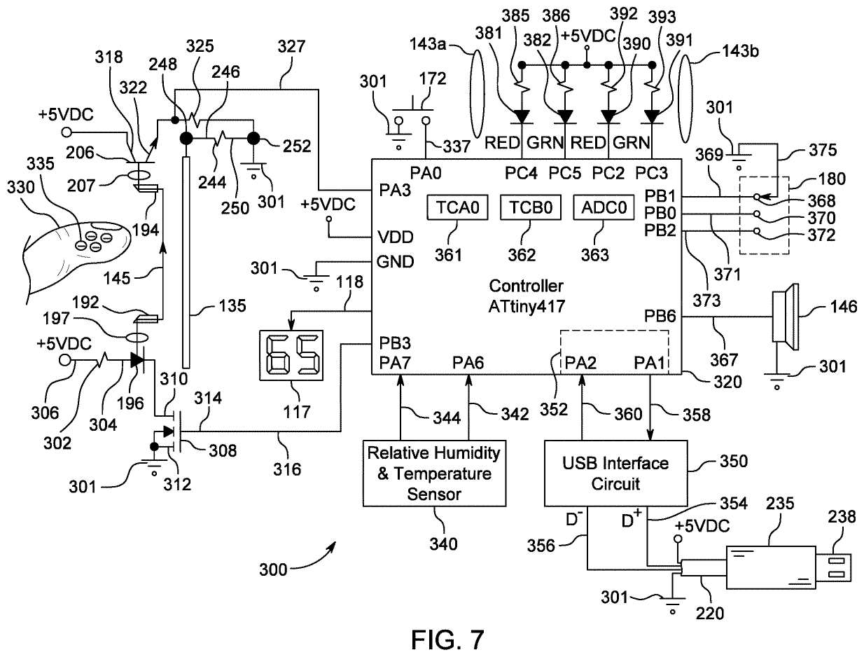

As used herein, “interaction with a user” includes a physical contact between the user and the conductive pad 135. The physical contact may include, but is not limited to, a finger 330 (shown in FIG. 7) of the user touching the conductive pad 135.

It is understood that a conductor of any shape or size and configured for interaction with the user may be substituted for the conductive pad 135, such as an exposed bare wire disposed on the surface 154.

The surface 140 may be provided with a conductive finish, including, but not limited to, electroless nickel immersion gold (ENIG). The conductive finish reduces oxidation and corrosion of the underlying copper layer which may result from repeated user interaction with the conductive pad 135. An optical path 145 may be defined across the conductive pad 135 and adjacent to the surface 140.

The bottom surface 139 includes a conductive pad 248. The conductive pad 135 is electrically connected to the conductive pad 248 through a metal-plated hole (not shown).

### The Bottom Surface 147 Includes a Conductive Pad 252.

A first LED indicator 445a and a second LED indicator 445b are affixed to the bottom surface 147 of the second printed circuit board 142 and are configured to project light upwardly, generally perpendicular to, and in the direction of, the surface 115. The lenses 143a and 143b are aligned with the LED indicators 445a and 445b, respectively, and are configured to focus the light produced by the LED indicators 445a and 445b toward the user.

The first printed circuit board 137, the second printed circuit board 142, and the insulator 142 (when solid) are configured to permit light produced by the LED indicators 445a and 445b to reach the lenses 143a and 143b, respectively, through one or more openings or gaps formed in first printed circuit board 137, the second printed circuit board 142, and the insulator 144 (when formed of a solid material).

The LED indicator 445a gives the user a visual indication of an operational state of the electrostatic discharge apparatus, and the LED indicator 445b gives the user a visual indication of a range for a given relative humidity value.

The LED indicator 445a may comprise a red LED 381 and a green LED 382. The LED indicator 445b may comprise a red LED 390 and a green LED 391. The LED indicators 445a and 445b may be part number AAA3528SURKCGKC09 bottom entry surface mount LEDs, or an equivalent part. The part number AAA3528SURKCGKC09 LED is manufactured by Kingbright North America having an office in City of Industry, California and distributed by DigiKey Corporation of Thief River Falls, Minnesota.

Formed into the inside surface 107 is a first rectangular groove 130a including an open end 131a and a closed end disposed opposite the open end 131a. The first rectangular groove 130a also includes an open top. Also formed into the inside surface 107 is a second rectangular groove 130b including an open end 131b and a closed end disposed opposite the open end 131b. The second rectangular groove 130b includes an open top.

The first rectangular groove 130a and the second rectangular groove 130b are aligned and disposed facing one another across the surface 140. The open ends 131a and 131b are located on the side wall 127.

With the stacked assembly affixed to the inside surface 107, the top surface 154 of the first printed circuit board 137 closes the open tops of the first rectangular groove 130a and the second rectangular groove 130b.

The first rectangular groove 130a and the second rectangular groove 130b are further configured to each receive an optical element, such as a first right-angle triangular prism 192 and a second right-angle triangular prism 194, respectively.

The first and second right-angle triangular prisms 192 and 194 are formed from a nonconductive, optically transmissive material. The optically transmissive material may include, but is not limited to, glass or acrylic (e.g., polymethyl methacrylate (PMMA)).

The first right-angle triangular prism 192 and the second right-angle triangular prism 194 are configured to deflect electromagnetic radiation by approximately ninety degrees via total internal reflection (TIR) at respective hypotenuse faces. The prisms 192 and 194 are further configured to include a first core and a second core, respectively, each core defined as having a non-hypotenuse face extending perpendicularly outward to form at least a portion of an optical waveguide.

The first and second cores of each prism 192 and 194, when received by the first and second rectangular grooves 130a and 130b, respectively, are substantially parallel to the surface 154.

The first right-angle triangular prism 192 may be configured such that, when received within the rectangular groove 130a, a second air gap is formed substantially surrounding all surfaces of the prism 192, the second air gap defining a cladding of a first optical waveguide.

The second right-angle triangular prism 194 may be configured such that, when received within the rectangular groove 130b, a third air gap is formed substantially surrounding all surfaces of the prism 194, the third air gap defining a cladding of a second optical waveguide.

A first optical waveguide 290 may comprise the first right-angle triangular prism 192 and the second air gap, and a second optical waveguide 295 may comprise the second right-angle triangular prism 194 and the third air gap.

The first optical waveguide 290 is configured to confine and direct the reflected electromagnetic radiation from the hypotenuse face of the right-angel triangular prism 192 along the optical path 145 using TIR. The second waveguide 295 is configured to confine and direct the electromagnetic radiation from the second rectangular groove 130b to the hypotenuse face of the right-angle prism 194 along the optical path 145 using TIR.

Alternately, the cladding may comprise a solid material applied to the surfaces of the right-angle triangular prisms 192 and 194, such as a fluorinated polymer. The refractive index of the cladding is less than the refractive index of the core material.

The first and second right-angle triangular prisms 192 and 194 may be affixed within the rectangular grooves 130a and 130b by an adhesive or by other fastening means (not shown). The bottom surface of each right-angle triangular prism 192 and 194 is substantially flush with the top surface 154 of the first printed circuit board 137.

The nonconductive prism material inhibits the buildup of electrostatically induced charge on the surfaces of the first and second right-angle triangular prisms 192 and 194 in response to a high voltage present on the conductive pad 135, the metal-plated hole, and the conductive pad 248, thereby reducing a likelihood of a secondary electrostatic discharge event occurring from the first and second right-angle triangular prisms 192 and 194 to other components of the electrostatic discharge apparatus 10.

An electromagnetic radiator 196 is affixed to the bottom side 147 of the second printed circuit board 142. The electromagnetic radiator 196 emits electromagnetic radiation towards the first printed circuit board 137 in a direction substantially perpendicular to the surface 154 and along the optical path 145.

The electromagnetic radiator 196 includes an integral focusing lens 197. The integral focusing lens 197 focuses the emitted electromagnetic radiation from the electromagnetic radiator 196 into a narrow beam.

The second printed circuit board 142 includes a hole 198. The electromagnetic radiator 196 is positioned such that an optical axis of the focusing lens 197 substantially aligns with the axis of the hole 198.

The insulator 144, when solid, is provided a slot 202 to permit the electromagnetic radiation from the integral focusing lens 197 to pass therethrough to the first printed circuit board 137. When the insulator 144 comprises an air gap, the slot 202 may be omitted.

The first printed circuit board 137 includes a slot 200 to permit the electromagnetic radiation emitted from the integral focusing lens 197 to pass therethrough and be incident upon the prism 192.

The slot 200 and the slot 202, when present, in combination with the hole 198, define an optical path 145 from the lens 197 to the right-angle triangular prism 192.

The prism 192 is configured to receive the electromagnetic radiation from the lens 197 and to reflect the electromagnetic radiation approximately ninety degrees, generally parallel to the surface 154, via total internal reflection (TIR) at the hypotenuse face through the first core, the reflected electromagnetic radiation continuing along the optical path 145. The prism 192 is further configured to form a thin, narrow sheet of electromagnetic radiation adjacent surface 140 along the optical path 145.

The electromagnetic radiation exits the right-angle triangular prism 192, and enters the first rectangular groove 130a, propagates therein, and exits the open end 131a along the optical path 145, continuing across and adjacent to, the surface 140 to enter the open end 131b of the second rectangular groove 130b.

The second rectangular groove 130b is configured to receive the thin, narrow sheet of electromagnetic radiation adjacent surface 140 and to direct the electromagnetic radiation along the optical path 145 toward the right-angle triangular prism 194.

The prism 194 is configured to receive the electromagnetic radiation from the second rectangular groove 130b, propagate the electromagnetic radiation through the second core, and reflect the electromagnetic radiation approximately ninety degrees, generally downward and perpendicular to the surface 154, via total internal reflection (TIR) at the hypotenuse face, the reflected electromagnetic radiation continuing along the optical path 145.

The first printed circuit board 137 is provided a slot 210 to allow the reflected electromagnetic radiation from prism 194 to pass therethrough. The insulator 144, when solid, is provided a slot 212 for allowing the reflected electromagnetic radiation from prism 194 to pass therethrough. When the insulator 144 comprises an air gap, the slot 212 may be omitted.

The second printed circuit board 142 is provided a hole 208 aligned with the slot 212 to allow the reflected electromagnetic radiation from prism 194 to pass therethrough and follow the optical path 145.

An electromagnetic detector 206 having an integral focusing lens 207 is affixed to the bottom side 147 of the second printed circuit board 142. The optical axis of the lens 207 is substantially aligned with an axis of the hole 208. The electromagnetic detector 206 is configured to be responsive to the reflected electromagnetic radiation from the prism 194.

The slot 210 (and the slot 212 if the insulator 144 is solid) in combination with the hole 208 continue the optical path 145 from the prism 194 to the lens 207.

It is noted that other optical elements may be substituted for the right-angle triangular prisms 192 and 194, and alternate configurations of the electromagnetic radiator 196, the first waveguide 290, the second waveguide 295, and the electromagnetic detector 206 are contemplated and are not limited to those disclosed herein. For example, in one configuration, the optical path 145 may extend substantially parallel to the surface 154, with the right-angle prisms 192 and 194 replaced by non-reflective optical elements.

The electromagnetic radiation emitted by the electromagnetic radiator 196 may be in the infrared spectrum. An example of electromagnetic radiator 196 may be model number VSMB2000X01, or an equivalent part. An example of a cooperating electromagnetic detector 206 may be model number VEMT2000X01, or an equivalent part. Both parts are manufactured by Vishay Intertechnology, Inc. of Malvern, Pennsylvania.

An audible indicator 146 is affixed to the bottom surface 147 of the second printed circuit board 142. A jack 214 is also affixed to the bottom surface 147. The side wall 151 is provided with a hole to accommodate the jack 214. The jack 214 connects to the power ground 301.

The side wall 151 further includes an audio access port 150. The port 150 provides an opening for projecting sound produced by the audible indicator 146 from the inside to the outside of housing 100.

The lower member 110 includes four rubber bumpers 155a-155d affixed to the bottom surface 175 at corners of the lower member 110. The bumpers 155a-155d provide a protective cushion when the electrostatic discharge apparatus 10 is placed on a supporting surface.

A reset switch 172 is affixed to the bottom surface 147 of the second printed circuit board 142. The reset switch 172 includes a switch stem 165. A switch stem hole 160 is provided in the bottom surface 175 for receiving the switch stem 165. The switch stem 165 protrudes through the bottom surface 175 and is accessible to the user. The reset switch 172 may be a tactile push button switch having a part number TL3305CF260G manufactured by E-Switch, Inc. of Minneapolis, Minnesota, or an equivalent part.

Formed on the bottom surface 175 is a circular shaped finger depression area 170. The finger depression area 170 facilitates the user inwardly pushing the switch stem 165 while preventing unintended activation of the reset switch 172.

A sound selector switch 180 is affixed to the bottom surface 147 of the second printed circuit board 142. The sound selector switch 180 includes a stem 187. A switch access slot 185 is provided in the bottom surface 175 for receiving the stem 187. The stem 187 protrudes through the bottom surface 175 and is accessible to the user. The sound selector switch 180 may be part number CL-SB-13B-0 manufactured by Nidec Components Corporation of Tokyo, Japan, or an equivalent part.

Also formed on the bottom surface 175 is a relative humidity and temperature port 189. The port 189 allows ambient air to enter the interior of housing 100 and to be in fluid communication with a relative humidity and temperature sensor 340 (shown in FIG. 7).

The second printed circuit board 142 includes a rectangular aperture 240 configured to receive a potting box 242. The potting box 242 includes an open top 245 and a bottom surface substantially flush with the bottom surface 139. The bottom surface of the potting box 242 is affixed to the bottom surface 139 of first printed circuit board 137 with an adhesive (not shown).

Disposed within the potting box 242 is an electrostatic charge dissipative element 244 having a first terminal 246 and a second terminal 250. The first terminal 246 is electrically connected to the conductive pad 248, and the second terminal 250 is electrically connected to the conductive pad 252. A slot 251 is provided in the wall of the potting box 242 to accommodate the second terminal 250. The conductive pad 252 is connected to the power ground 301 (shown in FIG. 7).

The bottom of potting box 242 includes a bottom opening 243 that exposes the conductive pad 248. The first terminal 246 is electrically connected to the conductive pad 248 and is therefore electrically connected to the conductive pad 135 through the metal-plated hole.

The electrostatic charge dissipative element 244 is disposed between the first and second printed circuit boards 137 and 142.

The insulator 144 maintains a physical separation between the printed circuit boards 137 and 142, thereby maintaining electrical isolation between the conductive pad 135 and the electrically grounded conductive pad 252.

The interior of the open-top potting box 242 is provided with an insulative potting compound 253 which encloses the electrostatic charge dissipative element 244, the conductive pad 248 and the bottom opening 243.

A high voltage that may be present on the conductive pad 135, the pad 248 and the electrostatic charge dissipative element 244 is substantially insulated from the second printed circuit board 142 by the insulator 144 and the insulative potting compound 253, thereby substantially reducing surface or bulk leakage currents to other electrical components which may be affixed to the second printed circuit board 142.

The electrostatic discharge current flowing from the conductive pad 135 to the ground connection 301 is substantially directed through the electrostatic charge dissipative element 244 and is thereby primarily controlled by the electrostatic charge dissipative element 244.

The electrostatic dissipative element 244 may include, but is not limited to, an HHV series resistor manufactured by the Yageo Corporation of New Taipei City, Taiwan, or an equivalent device.

For example, in response to a voltage of +/−30,000 volts applied to the conductive pad 135, and where the electrostatic charge dissipative element 244 comprises a resistor having a resistance of 30 megaohms, an electrostatic discharge current of approximately 1 mA flows from the conducting pad 135 to the power ground 301. This magnitude of discharge current may only cause a faint tingling sensation to the user.

In comparison, an uncontrolled electrostatic discharge event where the conductive pad 135 is directly connected to a ground connection may produce many amperes of electrostatic discharge current resulting in a painful shock to the user and the production of a spark.

The electrostatic dissipative element 244 may also comprise a piece of dissipative plastic material having electrical contacts on the ends of the material, or may comprise a non-linear electrostatic dissipative element.

The insulative potting compound 253 may be part number DP270 epoxy potting compound manufactured by the 3M Company of St. Paul, Minnesota, or an equivalent compound.

Referring now to FIG. 7, a schematic diagram of a circuit 300 of the electrostatic discharge apparatus 10 is shown comprising a controller 320, the conductive pad 135, the conductive pads 248 and 252, the relative humidity and temperature sensor 340, a USB interface circuit 350, the audible indicator 146, the sound selector switch 180, the alphanumeric LCD display 117 and the USB cable 220.

As used herein, the controller 320 may comprise any suitable microcontroller, such as the ATtiny417 microcontroller manufactured by Microchip Technology Inc. of Chandler, Arizona. The ATtiny417 microcontroller is described in data sheet DS40002288A, which is incorporated herein by reference. However, one of ordinary skill in the art will understand that other controllers may be substituted for the controller 320, and reference to the ATtiny417 microcontroller is not intended to be limiting.

Further in FIG. 7, the +5V DC supply voltage is noted as +5VDC for clarity.

The controller 320 includes programmable input/output (I/O) port pins PA0, PA1, PA2, PA3, PA6, PA7, PB0, PB1, PB2, PB3, PB6, PC2, PC3, PC4, and PC5. The port pins may be individually configured as an input pin or as an output pin.

Each input pin includes a pull-up resistor which may be programmatically enabled or disabled. The controller 320 is electrically powered by the +5V DC supply voltage and the power ground 301 connected to the VDD and GND pins, respectively.

The controller 320 further includes flash program memory, static random access data memory (SRAM), and electrically erasable programmable read only data memory (EEPROM).

The controller 320 further includes a TCA0 timer 361, a TCB0 timer 362, and an analog to digital (A/D) ADC0 converter 363.

The TCA0 timer 361 is configured as a two-second timer. The TCA0 timer 361 is described in the document TB3217 “Getting Started with Timer/Counter Type A (TCA)” published by Microchip Technology Inc., and is incorporated herein by reference.

The TCB0 timer 362 may be configured to produce a 4 KHz square wave. The TCB0 timer 362 may be configured to be responsive to a timed-delay response and to controllably output the 4 KHz square wave onto port pin PB6. The TCB0 timer 362 is described in the document TB3214 “Getting Started with Timer/Counter Type B (TCB)” published by Microchip Technology Inc., and is incorporated herein by reference.

The ADC0 converter 363 is configured for an 8-bit conversion. The ADC0 converter 363 is described in the documents “ADC Basics with tinyAVR 0- and 1 series, and megaAVR 0-series (AN2573) document DS90002573C and “Getting Started with ADC” (TB3209) document DS90003209A, both of which are published by Microchip Technology Inc., and both documents are incorporated herein by reference.

The controller 320 further includes programmable logic circuits which may perform switching functions depending upon the logical state of the input and output port pins. The port pins are further discussed in the Technical Brief TB3229 published by Microchip Technology Inc., and is incorporated herein by reference.

The controller 320 further includes a Universal Synchronous-Asynchronous Receiver-Transmitter (USART) 352. The USART 352 is configured to send and receive data to and from the USB interface circuit 350. The USART is further discussed in the Technical Brief TB3216 published by Microchip Technology Inc., and is incorporated herein by reference.

The conductive pad 135 connects to the conductive pad 248 and further connects to the first terminal 246 of the electrostatic charge dissipative element 244 (shown as a resistor in FIG. 7). The second terminal 250 of the electrostatic charge dissipative element 244 connects to the conductive pad 252. The conductive pad 252 further connects to the power ground 301.

The electrostatic charge dissipative element 244 may be configured to limit the discharge current from the conductive pad 135 to the power ground 301 to an acceptable value (which may be 1 mA or less) depending upon the maximum electrostatic voltage expected on the conductive pad 135, thus reducing the painful sensation experienced by the user during the electrostatic discharge event.

Further shown in FIG. 7 is the electromagnetic radiator 196. An anode terminal of the electromagnetic radiator 196 connects to a second terminal 304 of a resistor 302. A first terminal 306 of the resistor 302 connects to the +5V DC supply voltage power sourced by the USB cable 220.

A cathode terminal of the electromagnetic radiator 196 connects to a drain terminal 310 of an N channel enhancement metal oxide semiconductor field effect transistor (MOSFET) 308. The transistor 308 may be part number FDN327N manufactured by On Semiconductor Corp. of Scottsdale, Arizona, or an equivalent device.

A source terminal 312 of the transistor 308 connects to the power ground 301, and a gate terminal 314 of the transistor 308 connects to the port pin PB3 of the controller 320 via an electrical conductor 316. The port pin PB3 is configured as an output pin.

The controller 320 may control the ON/OFF state of the transistor 308 via a voltage placed on the port pin PB3. Connecting the port pin PB3 to substantially the +5V DC supply voltage turns ON the transistor 308 and allows current to flow from the +5V DC supply voltage through the resistor 302, through the electromagnetic radiator 196 and into the drain terminal 310 of the transistor 302, through the channel of the transistor 308 and out of the source terminal 312 to the power ground 301.

With the transistor 308 ON, the electromagnetic radiator 196 is enabled and emits electromagnetic radiation. To disable the electromagnetic radiator 196, the controller 320 connects the port pin PB3 substantially to the power ground 301.

Additionally shown in FIG. 7 is the electromagnetic detector 206. A collector terminal 318 of the electromagnetic detector 206 is connected to the +5V DC supply voltage and an emitter terminal 322 is connected to a first terminal of a sensing resistor 325. The first terminal of the sensing resistor 325 also connects to the port pin PA3 via an electrical conductor 327. A second terminal of the resistor 325 connects to conductive pad 252. The port pin PA3 is configured as an input pin.

The electromagnetic detector 206 in response to the incident electromagnetic radiation switches ON and applies substantially the +5V DC supply voltage to the first terminal of resistor 325 and to the port pin PA3 of controller 320 via the electrical conductor 327. The controller 320 may perform switching functions in response to the interpreted logical state of the port pin PA3 voltage.

Electromagnetic radiation emitted by the electromagnetic radiator 196 follows the optical path 145 from the electromagnetic radiator 196, through the lens 197, through the prism 192, across and adjacent to the surface of the conductive pad 135, through the prism 194, through the lens 207, and to the electromagnetic detector 206.

A sensor 275 may comprise the infrared electromagnetic radiator 196, the first optical waveguide 290, the second optical waveguide 295, and the infrared electromagnetic detector 206. The sensor 275 being operable to detect user interaction with the conductive pad 135.

Also shown in FIG. 7 is the human finger 330. The finger 330 may have a net accumulation of negative charge 335. It is noted that the net accumulation of charge on finger 330 may also be of opposite polarity.

To discharge the accumulated negative charge 335, the user interacts with the conductive pad 135. The accumulated charge 335 is dissipated through the conductive pad 135, the electrostatic charge dissipative element 244, and the power ground 301. The user interaction with the conductive pad 135 also obstructs the optical path 145, the finger 330 being opaque to the electromagnetic radiation.

Given an unobstructed optical path 145, the voltage at the port pin PA3 is substantially the +5V DC supply voltage and may be interpreted as a logic 1 signal by the controller 320.

Given an obstructed optical path 145, the voltage on the port pin PA3 is substantially 0 volts and may be interpreted as a logic 0 signal by the controller 320.

The interpreted logic state of the port pin PA3 voltage therefore defines whether the user has interacted with the conductive pad 135 and simultaneously discharged the accumulated negative charge 335.

The circuit 300 further includes the reset switch 172. One terminal of the reset switch 172 connects to the port pin PA0 via an electrical conductor 337 and the other terminal of the reset switch 172 connects to the power ground 301. The port pin PA0 is configured as a reset input pin. Depressing the reset switch 172 performs a hardware reset of the controller 320.

Further included in circuit 300 is the relative humidity and temperature sensor 340. The relative humidity and temperature sensor 340 is configured to sense a relative humidity RH(%) 816 and a temperature of the ambient air via the port 189, and to further generate a voltage signal V(Pin PA6) representative of the RH(%) 816 and to generate a voltage signal V(Pin PA7) representative of the temperature.

The sensor 340 communicates the relative humidity voltage signal V(Pin PA6) to the port pin PA6 of the controller 320 via an electrical conductor 342, and also communicates the temperature voltage signal V(Pin PA7) to the port pin PA7 of the controller 320 via an electrical conductor 344. The port pins PA6 and PA7 are configured as analog to digital input pins. The voltages on the port pins PA6 and PA7 are multiplexed within the controller 320 and connect to the ADC0 converter 363.

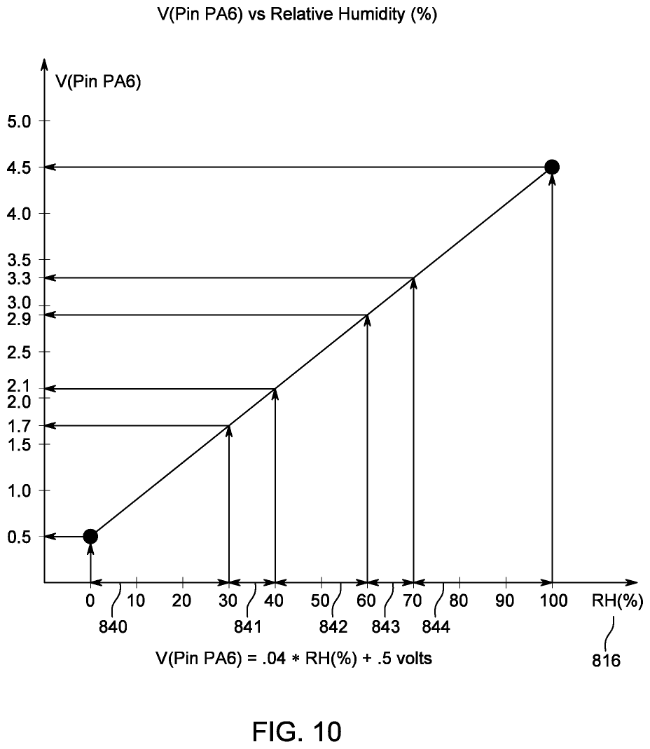

As shown in FIG. 10, the relationship between the relative humidity RH(%) 816 and the voltage signal V(Pin PA6) is governed by the transfer function V(Pin PA6)=0.04*RH(%)+0.5 volts.

The sensor 340 may be part number HTU31V manufactured by TE Connectivity Corporation of Berwyn, Pennsylvania, or an equivalent device.

The circuit 300 further includes the USB cable 220. The USB cable 220 provides a differential serial data pair signals comprising a data signal D+ and a data signal D− to the circuit 300.

The differential data pair signals D+ and the D− flow to the USB Interface circuit 350 via electrical conductors 354 and 356, respectively. The USB protocol provides for data exchange between connected USB devices through the differential serial data pair signals D+ and D−.

The connector 235 connects to an external power source to provide the +5V DC supply voltage (with respect to the power ground 301) to the circuit 300. An example of the external power source is, but is not limited to, the AC to DC power converter 400 shown in FIGS. 8A and 8B.

The individual wires of USB cable 220 are electrically connected to the second printed second printed circuit board 142 using soldered connections or an electrical connector, or a combination of both (not shown).

The circuit 300 further includes a USB interface circuit 350. The USB interface circuit 350 is configured to provide secure and reliable USB communication and may include a USB controller. The USB interface circuit 350 is well documented in the art.

An example of the USB interface circuit 350 is provided, but is not limited to, within the ATtiny817 Xplained Mini evaluation kit documentation manufactured by Microchip Technology Inc. This documentation includes the ATtiny817 Xplained Mini User Guide DS50002657B and a schematic diagram, both of which are incorporated herein by reference. The schematic diagram includes an ATmega32U4 USB microcontroller as the USB controller.

Data is transmitted from the USART 352 via the port pin PA1 to the USB interface circuit 350 via an electrical conductor 358. Data is received by the USART 352 via the port pin PA2 from the USB interface circuit 350 via an electrical conductor 360. The port pin PA1 is configured as an output TxD port pin and the port pin PA2 is configured as an input RxD port pin.

Thus, it is understood that controller 320 may be configured to send and to receive data from connected USB devices via the USB interface circuit 350 and the differential D+and D-data signals. Some examples of the data that may be sent or received by the circuit 300 may include, but is not limited to, the relative humidity and temperature data and the number of times the user has interacted with the conducting pad 135.

The circuit 300 further includes the audible indicator 146. The audible indicator 146 connects to the port pin PB6 through an electrical conductor 367. A second terminal of the audible indicator 146 is connected to the power ground 301. The audible indicator 146 may also include a vibrator motor (not shown) or other types of audible or vibratory indicators. The port pin PB6 is configured as an output pin.

The TCB0 timer 362, and therefore the audible indicator 146, may be configured to be responsive to the time-delayed response. The audible indicator 146 may be a model CMT-1203 manufactured by Same Sky (formally CUI Devices) of Lake Oswego, Oregon, or an equivalent device.

Further shown in FIG. 7 is the sound selector switch 180. The sound selector switch 180 connects to the controller 320 having a first switch position 368 connecting to the port pin PB1 via an electrical conductor 369, a second switch position 370 connecting to the port pin PB0 via an electrical conductor 371, and a third switch position 372 connecting to the port pin PB2 via the electrical conductor 373. A common terminal 375 of the sound selector switch 180 is connected to the power ground 301.

The port pins PB1, PB0, and PB2 are configured as input pins with their respective pull-up resistors activated. The controller 320 is configured to determine the selected switch position of the sound selector switch 180 based on the logic state for each port pin PB1, PB0, or PB2. When the sound selector switch 180 is in an ON position, the logic state of the corresponding port pin is 0, having the corresponding port pin being connected to power ground 301. The non-corresponding port pins are at +5V DC supply voltage and interpreted as a logic 1.

Further connected to controller 320 is a cathode terminal of the red LED 381 which connects to the port pin PC4, and a cathode terminal of the green LED 382 which connects to the port pin PC5.

An anode terminal of the red LED 381 connects to the first terminal of a resistor 385 and an anode terminal of the green LED 382 connects to a first terminal of a resistor 386. A second terminal of the resistor 385 and a second terminal of the resistor 386 are both connected to the +5V DC supply voltage.

Additionally connected to controller 320 is a cathode terminal of the red LED 390 which connects to the port pin PC2, and a cathode terminal of a green LED 391 which connects to the port pin PC3.

An anode terminal of the red LED 390 connects to a first terminal of resistor 392 and an anode terminal of the green LED 391 connects to a first terminal of a resistor 393. A second terminal of the resistor 392 and a second terminal of the resistor 393 are both connected to the +5V DC supply voltage.

The port pins PC2, PC3, PC4, and PC5 are configured as output pins such that the controller 320 selectively turns on one or more LEDS 381, 382, 390 and 391 by setting the corresponding port pin(s) to a logic state of 0, thereby connecting the corresponding port pin substantially to power ground 301. In the logic state of 0, the cathode of each corresponding LED is substantially coupled to the power ground 301, permitting current to flow from the +5 V DC supply voltage through the corresponding LED to illuminate the LED.

The port pins PC2, PC3, PC4, and PC5 may be further configured to respond to the time-delayed response such that the LED indicators 445a or 445b are controlled in accordance with the time-delayed response.

Additionally, simultaneously illuminating both the red and green LEDs of either the LED indicator 445a or 445b produces an amber-like color.

The alphanumeric LCD display 117 is connected to controller 320 via a data bus 118. The data bus 118 may be configured as, but not limited to, a serial bus. For clarity, a power connection and a ground connection to the alphanumeric LCD display 117 are not shown. Displaying data from the controller 320 to the LCD alphanumeric display 117 is well known in the art.

Display 117 may display the relative humidity and temperature in degrees Centigrade or degrees Fahrenheit. The number of digits displayed by LCD 117 as shown is two digits, but may be increased accordingly to accommodate the number of digits required for displaying the desired data. For example, to display Fahrenheit integer temperatures exceeding 99 degrees and 100% relative humidity would require 3 digits.

Referring to FIGS. 8A and 8B, the AC to DC power converter 400 is shown having a rectangular housing 401. The rectangular housing 401 includes a front surface 405 and a back surface 412. The AC to DC power converter 400 is configured to provide the +5V DC supply voltage (with respect to the power ground 301) from an earth grounded AC power socket.

The USB female connector 410 is disposed on the back surface 412. The +5V DC supply voltage and the power ground 301 are connected to the USB female connector 410. The USB male connector 235 may be inserted into the female USB connector 410 to provide the +5V DC supply voltage and the power ground 301 to the circuit 300 via the USB cable 220.

Disposed on the front surface 405 is a first AC input prong 402 (commonly referred to as the hot terminal), a second AC input prong 404 (commonly referred to as the neutral terminal) and an earth ground prong 406.

The prongs 402, 404 and 406 may be configured to be insertable into a residential United States earth grounded 3-prong AC power socket (not shown). The AC input prongs 402 and 404 and the earth ground prong 406 may be configured for other types of AC power sockets, such as European AC power sockets.

Within the AC to DC power converter 400 the earth ground prong 406 is connected to the power ground 301. With the AC to DC power converter 400 inserted into the AC power socket, the earth ground prong 406, and therefore the power ground 301, are connected to the earth ground of the 3-prong AC power socket.

With the AC to DC power converter 400 detached from the 3-prong AC power socket, the +5V DC supply voltage is removed from the USB female connector 410. Additionally, detaching the AC to DC converter 400 also breaks the earth ground prong 406 electrical connection to the earth ground of the AC power socket. With the USB +5V DC supply voltage removed the circuit 300 is powered off, and the LED indicators 445a and 445b will not illuminate.

Thus, the loss of +5V DC supply voltage on the USB male connector 235 and the resultant non-illumination of the LED indicators 445a or 445b may be used to inform the user that the AC to DC converter 400 is detached from the AC power socket and that the power ground 301 is disconnected from the earth ground connection of the AC power socket.

With the power ground 301 disconnected from the earth ground connection of the AC socket, the accumulated charge 335 is prevented from flowing from the conductive pad 135 through the electrostatic charge dissipative element 244 through the power ground 301 to the earth ground prong 406 and finally to the earth ground of the AC power socket. With the earth ground prong 406 disconnected from the earth ground of the AC power socket, the user is unable to discharge the accumulated charge 335.

A similar situation occurs if the USB male connector 235 is detached from the female USB connector 410 even though the AC to DC power converter 400 may remain attached to the AC power socket.

Alternately, the male USB connector 235 may be inserted into a female USB connector on an earth grounded computer which provides the +5V DC supply voltage with respect to the power ground 301 and further having the power ground 301 connected to the earth ground of the AC power socket.

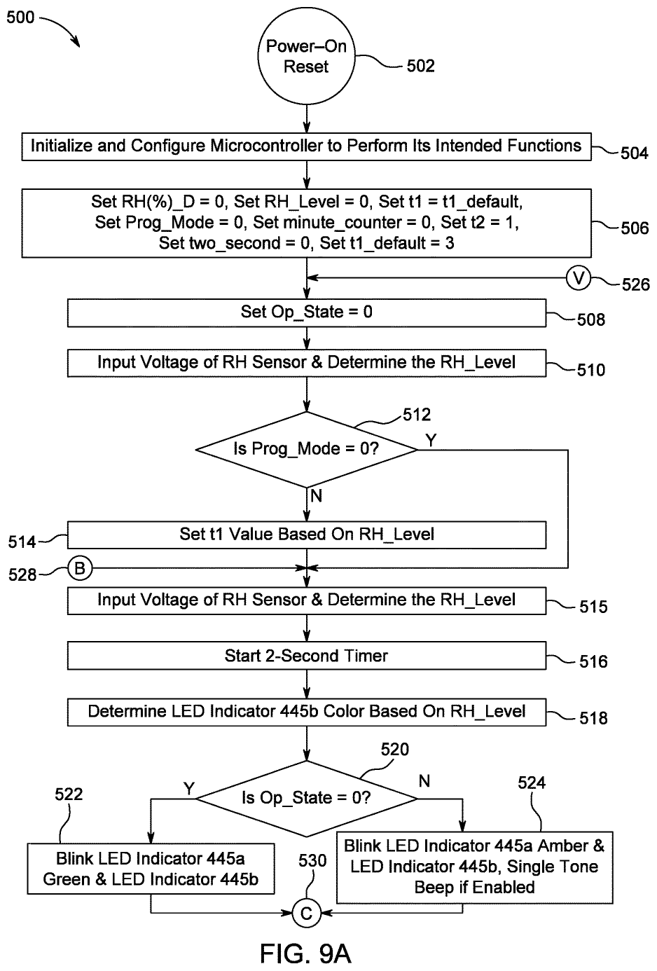

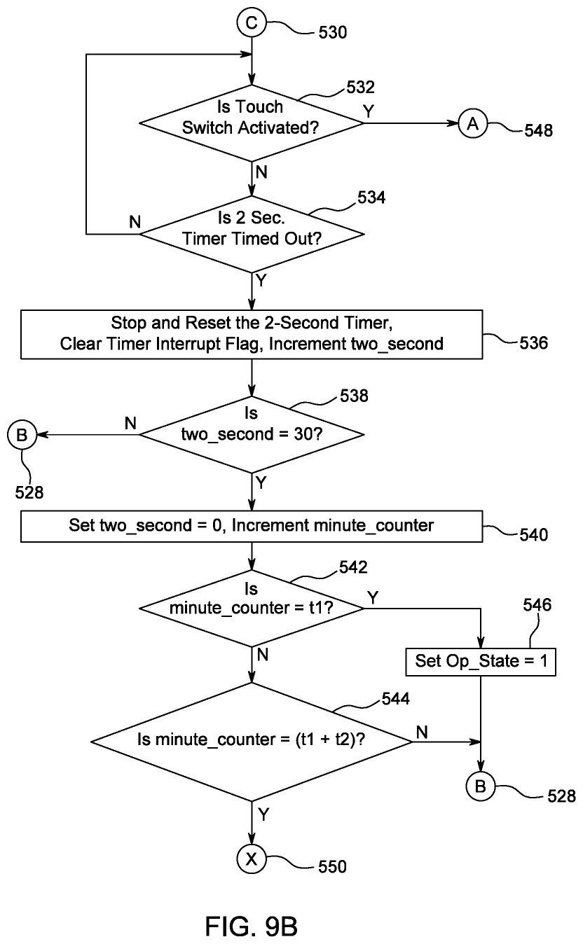

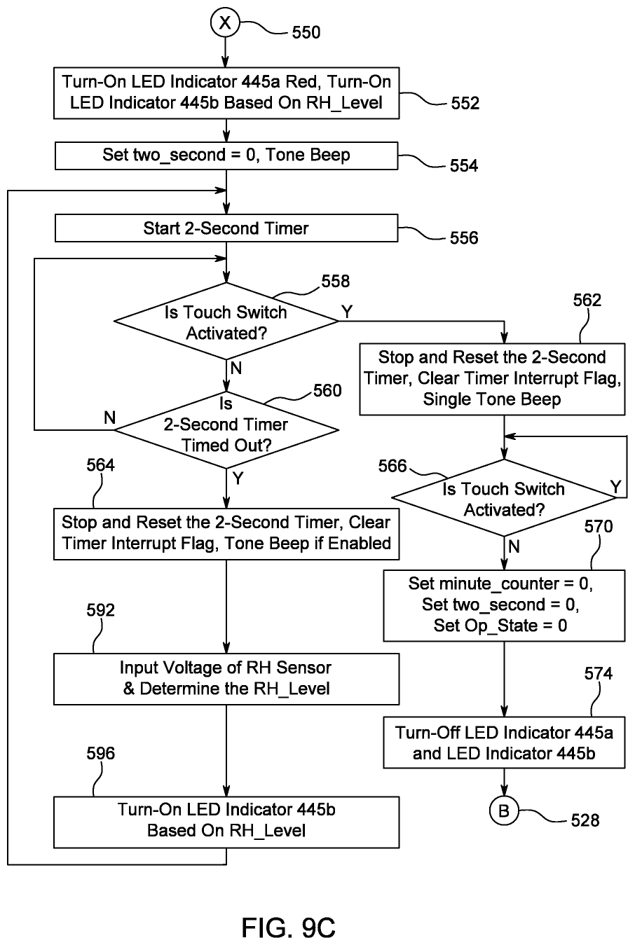

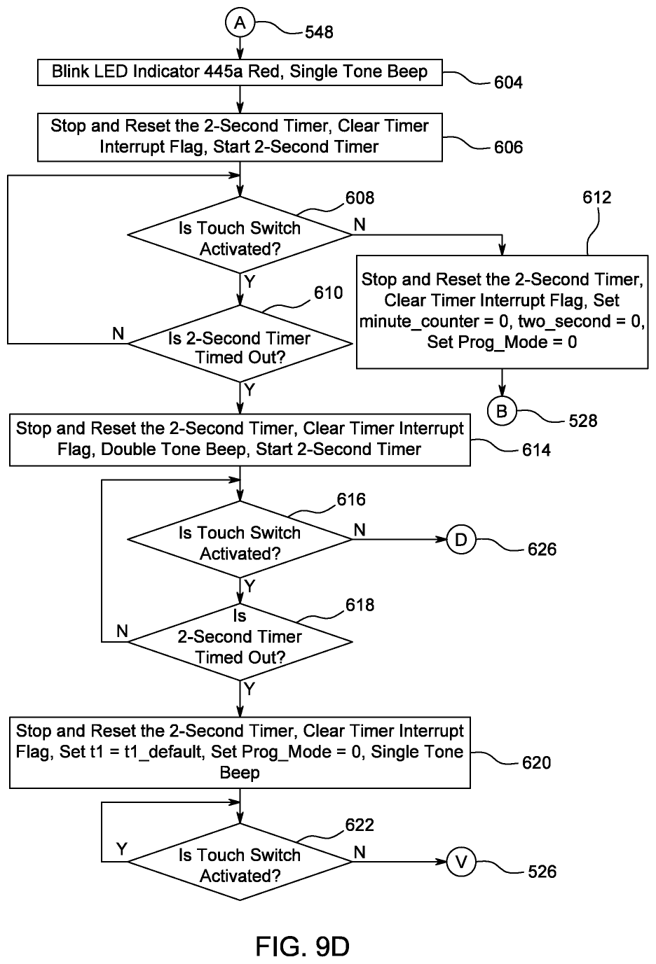

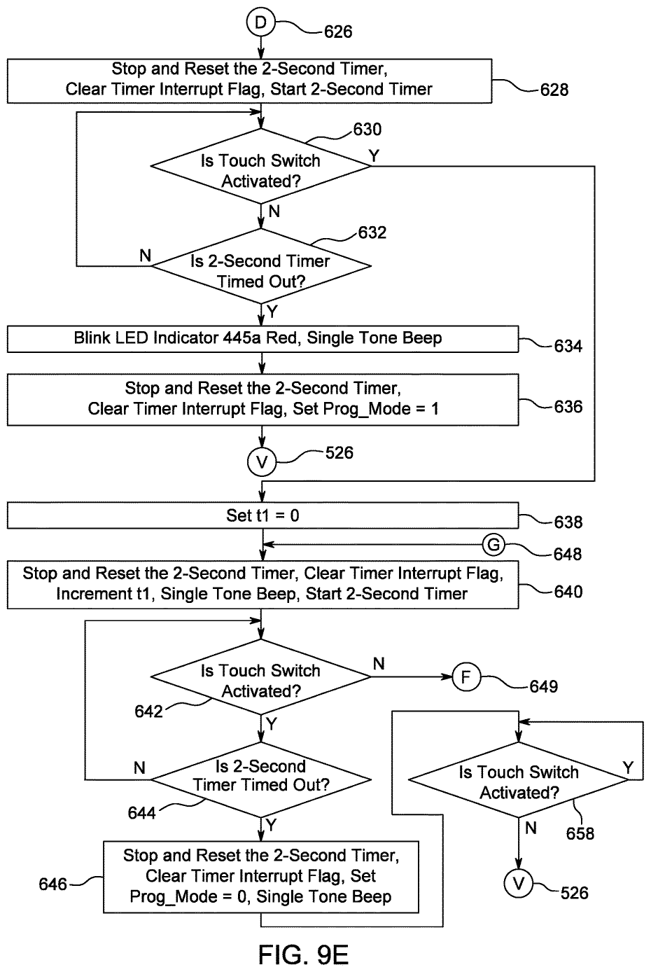

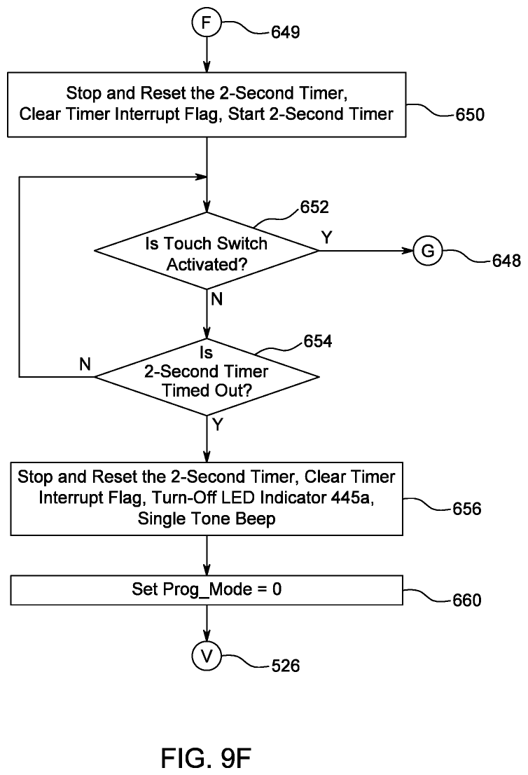

Referring to FIG. 9A-9F, the operational flow chart 500 of the electrostatic dissipator apparatus 10 is shown.

All constants are listed as standard base-10 numbers in FIGS. 9A-9F.

The phrase “Is Touch Switch Activated?” in the FIGS. 9A-9F shall mean that the controller 320 first inputs the voltage on port pin PA3 from the sensor 275 and determines the logic state of the port pin PA6 voltage. If the user interacts with the conductive pad 135, the voltage on the port pin PA3 will be substantially at the power ground 301 and the logic level will be 0 (Touch Switch Activated). If the user does not interact with the conductive pad 135, the voltage on the port pin PA3 will be substantially at the +5V DC supply voltage and the logic level will be 1 (Touch Switch Not Activated). The controller 320 is configured to conditionally branch depending upon the logical state of the port pin PA3 voltage.

In FIGS. 9A-9F, the phrase “2 Second Timer” refers to the TCA0 timer 361, the phrase “Stop and Reset the 2-Second Timer” refers to disabling the TCA0 timer 361 and then setting the base counter register (CNT) of the TCA0 timer 361 to 0, and the phrase “Clear Timer Interrupt Flag” shall mean setting the overflow interrupt flag (OVF) of the TCA0 timer 361 to 0.

For clarity, only the register names are given in FIGS. 9A-9F. For example, step 508 states “Set Op_State=0”. This statement is interpreted as “set the value of the Op_State register 809 to 0”, and in step 512 states “Is Prog_Mode=0?” is interpreted as “Is the value of the Prog_Mode register 802 equal to 0”.

It is assumed that the AC to DC power converter 400 has been previously inserted into an energized AC power socket and the male USB connector 235 has been inserted into the USB female connector 410 thereby having the USB cable 220 provide the +5V DC supply voltage and the power ground 301, and additionally the earth ground from the AC power socket, to the circuit 300.

In step 502 and in response to being powered on by the +5V DC supply voltage, the controller 320 is configured to perform a power-on-reset (POR) initialization. The POR initialization process for the ATtiny417 controller is described in the data sheet DS40002288A previously mentioned. Program flow then continues to step 504.

In step 504, the controller 320 is configured to initialize its internal peripherals to perform the intended functions of the controller 320. The internal peripherals may include, but are not limited to, the input/output port pins, the TCA0 timer 361, the TCB0 timer 362, the ADC0 converter 363, and the USART 352. Program flow then continues to step 506.

In step 506, the controller is configured to initialize the program variables and registers. The program registers comprise 8-bit registers and include, but are not limited to, a Prog_Mode register 802, a t1 register 804, a t1_default register 805, a t2 register 808, an Op_State register 809, a minute_counter register 810, a two_second register 812, a RH(%)_D register 813 and a RH_Level register 824.

Additionally in step 506, the Prog_Mode register 802 is set to 0, the t1 default register 805 is set to 3 and then the t1 register 804 is set to the value contained in the t1 default register 805, the t2 register 808 is set to 1, the minute_counter register 810 is set to 0, the two_second register 812 is set to 0, the RH(%)_D register 813 is set to 0, and the RH_Level register 824 is set to 0.

Also, in step 506, the controller 320 is configured to illuminate the LED indicators 445a and 445b if +5V DC supply voltage and the power ground 301 are applied to circuit 320. The illumination of LEDs 445a and 445b provides the user a visual indication that the electrostatic dissipater apparatus 10 is powered and therefore both the +5V DC supply voltage and the power ground 301, and the earth ground of the AC power socket are connected to the circuit 300. Program flow then continues to step 508.

Program flow also continues to step 508 from ‘V’526.

In step 508, the controller 320 sets the Op_State register 809 to 0.

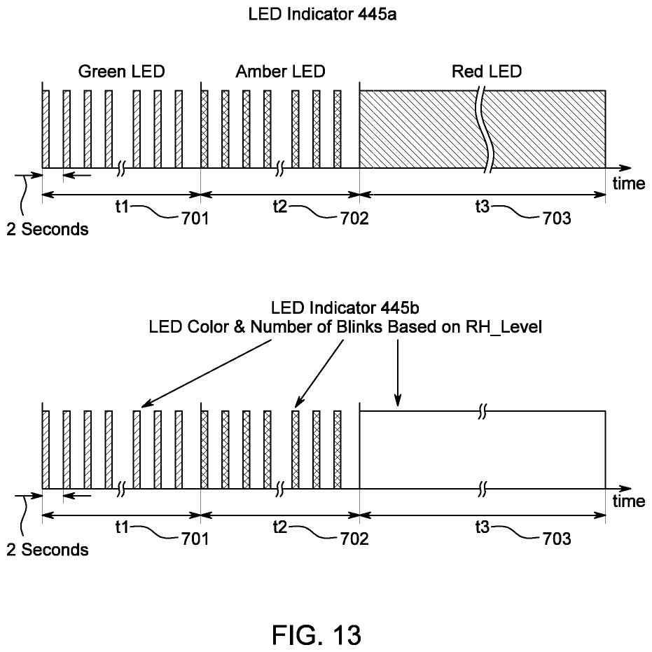

The electrostatic discharge apparatus 10 has three operational states corresponding to a time interval t1 701, a time interval t2 702, and a time interval t3 703, as shown in FIG. 13.

During the time interval t1 701, the Op_State register 809 is set to 0. During the time interval t2 702, the Op_State register 809 is set to 1. The three operational states of the electrostatic discharge apparatus 10 are further discussed with reference to FIG. 13. Program flow then continues to step 510. The time-delayed response occurs at the end of the time interval t1 701.

In step 510 and referring to FIG. 10, the controller 320 is configured to input the voltage on port pin PA6 from the relative humidity and temperature sensor 340 and to convert this voltage to the RH(%) 816 value based on the transfer function given in FIG. 10. The controller 320 is further configured to digitize this voltage using the ADC0 converter 363 and to store the digitized value in the RH(%)_D register 813.

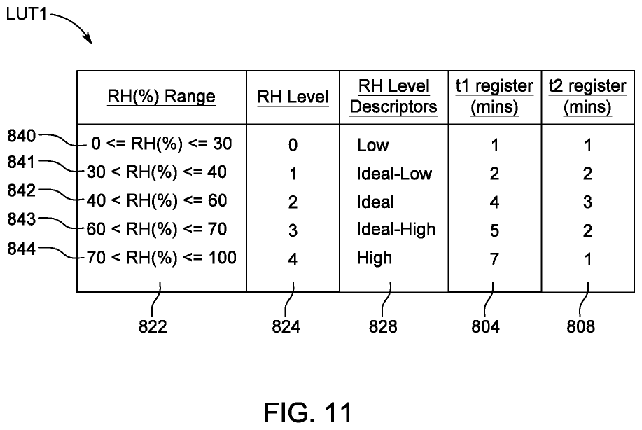

The controller 320 is further configured to classify the RH(%) 816 data into one of the five listed ranges 822 as shown in table LUT1 of FIG. 11. The controller 320 is also configured to determine the value of the RH_Level register 824 based on the table LUT1. The table LUT1 may be stored in the EEPROM memory of the controller 320.

It is understood that the data listed in table LUT1 are illustrative, and that the RH_Level Descriptor 828 is a descriptive label for the RH(%) 822 ranges.

A first range 840 comprises RH(%) 816 data from 0% to 30%, inclusive. For this range, the controller 320 is configured to set the RH_Level register 824 to 0, the t1 register 804 to 1, and the t2 register 808 to 1.

A second range 841 comprises RH(%) 816 data greater than 30% and less than or equal to 40%. For this range, the controller 320 is configured to set the RH_Level register 824 to 1, the t1 register 804 to 2, and the t2 register 808 to 2.

A third range 842 comprises RH(%) 816 data greater than 40% and less than or equal to 60%. For this range, the controller 320 is configured to set the RH_Level register 824 to 2, the t1 register 804 to 4, and the t2 register 808 to 3.

A fourth range 843 comprises RH(%) 816 data greater than 60% and less than or equal to 70%. For this range, the controller 320 is configured to set the RH_Level register 824 to 3, the t1 register 804 to 5, and the t2 register 808 to 2.

A fifth range 844 comprises RH(%) 816 data greater than 70% to less than or equal to 100%. For this range, the controller 320 is configured to set the RH_Level register 824 to 4, the t1 register 804 to 7, and the t2 register 808 to 1.

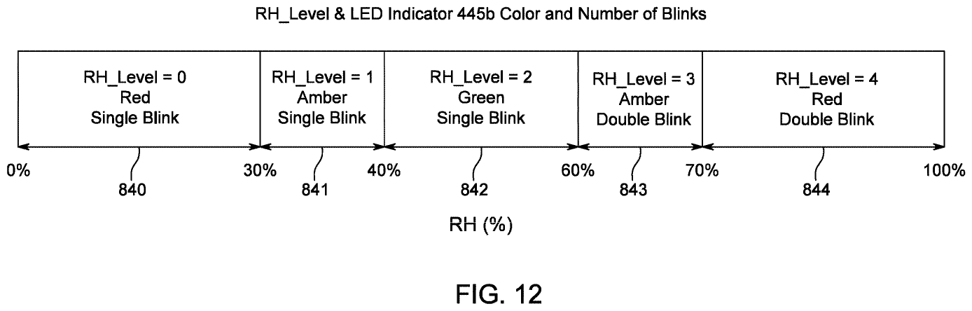

Referring to FIG. 12, the controller 320 is further configured to set the color and the number of blinks of the LED indicator 445b based on the value of the RH_Level register 824.

For example, when the RH(%) 816 is within the first range 840, the RH_Level register 824 is set to 0. The controller 320 is configured to periodically cause the LED indicator 445 b to emit a single red blink to visually alert the user of a low relative humidity condition.

For example, when the RH(%) 816 is within the second range 841, the RH_Level register 824 is set to 1. The controller 320 is configured to periodically cause the LED indicator 445b to emit a single amber blink to visually alert the user of an ideal-low relative humidity condition.

For example, when the RH(%) 816 is within the third range 842, the RH_Level register 824 is set to 2 and the controller 320 is configured to periodically cause the LED indicator 445b to emit a single green blink to visually alert the user of an ideal relative humidity condition.

For example, when the RH(%) 816 is within the fourth range 843, the RH_Level register 824 is set to 3 and the controller 320 is configured to periodically cause the LED indicator 445b to emit a double amber blink to visually alert the user of an ideal-high status relative humidity condition.

For example, when the RH(%) 816 is within the fifth range 844, the RH_Level register 824 is set to 4 and the controller 320 is configured to periodically cause the LED indicator 445b to emit a double red blink to visually alert the user of a high relative humidity condition.

Referring again to FIG. 9A, program flow continues from step 510 to step 512.

In step 512, the controller 320 is configured to determine whether the Prog_Mode register 802 equals 0. If the Prog_Mode register 802 equals 0, program flow proceeds to step 515. Otherwise program flow proceeds to step 514.

The value of the Prog_Mode register 802 may indicate whether the t1 register 804 has been set manually, in which case the Prog_Mode register 802 set to 0, or automatically based on the RH(%) 816, in which case the Prog_Mode register 802 is set to 1.

In step 514, the controller 320 is configured to set the value of the t1 register 804 equal to the value listed in FIG. 11 based on the RH_Level register 824 value. The significance of the t1 register 804 value is discussed later with respect to FIG. 13. Program flow continues to step 515.

Program flow also continues to step 515 from ‘B’528.

In step 515, the controller 320 is configured to input the voltage from the relative humidity and temperature sensor 340 from the port pin PA6 and to determine the RH_Level register 824 value according to table LUT1.

Program flow continues to step 516.

In step 516, the controller 320 is configured to start the TCA0 timer 361. The TCA0 timer 361 may count for a period of approximately 2 seconds, after which an overflow interrupt flag (OVF) of the TCA0 timer 361 is set. The overflow interrupt flag (OVF) may be polled by the program to indicate that the TCA0 timer 361 has timed out. Program flow continues to step 518.

In step 518, the controller 320 is configured to select a color for LED indicator 445b according to the value of the RH_Level register 824 as indicated in FIG. 12. Program flow continues to step 520.

In step 520, the controller 320 is configured to determine whether the value of the Op_State register 809 equals 0. If the value equals 0, program flow continues to step 522. Otherwise, program flow continues to step 524.

In step 522, the controller 320 is configured to cause the LED indicator 445a to emit a single green blink and to cause the LED indicator 445b to emit either a single blink or a double blink in a color corresponding to the value of the RH_Level register 824, as shown in FIG. 12.

The controller 320 may further cause the value of the RH(%)_D register 813 to be displayed on the alphanumeric display 117. Program flow continues to step 532 in FIG. 9B via ‘C’ 530.

In step 524, the controller 320 is configured to cause the LED indicator 445a to emit a single amber blink and to cause the LED indicator 445b to emit either a single blink or a double blink in a color corresponding to the value of the RH_Level register 824, as shown in FIG. 12.

Further in step 524, the controller 320 is configured to determine whether a single tone beep is to be sounded when enabled by the sound selector switch 180. The position of the common terminal 375 of the sound selector switch 180 determines whether the single-tone beep in step 524 is sounded. For example, the tone beep may be generated in step 524 when the sound selector switch 180 is in the third position connecting the common terminal 375 to the third-position terminal 372. The controller 320 controllably enables the TCB0 timer 362 to generate and output a 4 KHz tone waveform to the audio indicator 146 via the electrical conductor 367.

Program flow continues to step 532 in FIG. 9B via ‘C’ 530.

Referring now to FIG. 9B, in step 532, the controller 320 is configured to determine whether a user interaction with the conductive pad 135 is occurring. If a user interaction is occurring, program flow continues to step 604 via ‘A’ 548 shown in FIG. 9D. Otherwise, program flow continues to step 534.

In step 534, the controller 320 is configured to determine if the TCA0 timer 361 has timed out based on the state of the overflow interrupt flag (OVF) of the TCA0 timer 361. If the TCA0 timer 361 has not timed out, program flow returns to step 532. Otherwise, program flow continues to step 536.

In step 536, the controller 320 is configured to stop and reset the TCA0 timer 361, to clear the overflow interrupt flag (OVF) of the TCA0 timer 361, and to increment the value of the two_second register 812 by 1. Program flow continues to step 538.

In step 538, the controller 320 is configured to determine whether the value of two_second register 812 equals 30. If the value is not equal to 30, program flow returns to step 515 in FIG. 9A via ‘B’ 528. Otherwise, program flow continues to 540.

In step 540, the controller is configured to set the value of the two_second register 812 to 0 and to increment the value of the minute_counter register 810 by 1. Program flow continues to step 542.

In step 542, the controller 320 is configured to determine whether the value of the minute_counter register 810 equals the value of the t1 register 804. If the value of the minute_counter register 810 equals the value of the t1 register 804, program flow continues to step 546. Otherwise, program flow continues to step 544.

In step 546, the controller 320 is configured to set the value of the Op_State register 809 equal to 1, thereby defining the end of the time interval t1 701 and the beginning of the second operational state defined by the time interval t2 702 in FIG. 13. Program flow returns to step 515 in FIG. 9A via ‘B’ 528.

In step 544, the controller 320 is configured to determine if the value of the minute_counter register 810 equals the sum of the values of the t1 register 804 and the t2 register 805. If the minute_counter register 810 equals the sum of the values of the t1 register 804 and the t2 register 808, program flow continues to step 552 in FIG. 9C via ‘X’ 550. Otherwise, program flow returns to step 515 in FIG. 9A via ‘B’ 528.

Step 552 defines the end of the time interval t2 702 and the beginning of the time interval t3 703.

In step 552, the controller 320 is configured to cause the LED indicator 445a to emit red light and to cause the LED indicator 445b to emit a color corresponding to the value of the RH_Level register 824 shown in FIG. 12. Program flow continues to step 554.

In step 554, the controller 320 is configured to set the value of the two_second register 812 to 0 and to enable the TCB0 timer 362 to produce a single tone beep. Program flow continues to step 556.

In step 556, the controller 320 is configured to start the TCA0 timer 361. Program flow continues to step 558.

In step 558, the controller 320 is configured to determine whether a user interaction is occurring. If a user interaction is occurring, program flow continues to step 562. Otherwise, program flow continues to step 560.

In step 560, controller 320 is configured to determine whether the TCA0 timer 361 has timed out by checking the timer overflow interrupt flag (OVF) of the TAC0 timer 361. If the TCA0 timer 361 has not timed out program flow returns to step 558. Otherwise, program flow continues to step 564.

In step 564, the controller 320 is configured to stop and reset the TCA0 timer 361 and to clear the overflow interrupt flag (OVF) of the TCA0 timer 361. The controller 320 may further produce a single tone beep depending on a position of the sound selector switch 180.

The controller 320 is configured to produce the tone beep in step 564 when the sound selector switch 180 is in either the third switch position connecting the common terminal 375 to the third switch position terminal 372, or a second position connecting the common terminal 375 to a second position terminal 370. Thus, a user may select when to be audibly alerted for either the second or a third operational states. Program flow continues to step 592.

In step 592, the controller 320 is configured to input the voltage on port pin PA6 and determine a value of the RH_Level register 824 based on the values listed in the LUT1 FIG. 11. Program flow continues to step 596.

In step 596, the controller 320 is configured to cause the LED indicator 445b to emit a color corresponding to the value of the RH_Level register 824. Program flow returns to step 556.

In step 562, the controller 320 is configured to stop and reset the TCA0 timer 361, to clear the overflow interrupt flag (OVF) of the TCA0 timer 361, and to produce a single tone beep indicating to the user that a user interaction has occurred.

In step 566, the controller 320 is configured to determine whether a user interaction is occurring. If the user interaction is occurring, program flow returns to step 566. Otherwise, program flow continues to step 570.

In step 570, controller 320 is configured to set the value of the minute_counter register 810 to 0, to set the value of the two_second register 812 to 0, and to set the value of the Op_State register 809 to 0. Program flow continues to step 574.

In step 574, the controller 320 is configured to cause both LED indicators 445a and the LED indicator 445b to stop emitting light. Program flow then returns to step 515 shown in FIG. 9A via ‘B’ 528.

Referring now to FIG. 9D, program flow continues from step 532 in FIG. 9B to step 604 in FIG. 9D via ‘A’ 548.

In step 604, the controller 320 is configured to cause the TCB0 timer 362 to emit a single tone beep and to cause the LED indicator 445a to emit a single red blink.

Both the single tone beep and the single red blink give the user audible and visual feedback informing the user that a successful interaction with the conductive pad 135 has occurred and that the user has been discharged. The duration of the tone beep is sufficient to have the user be completely discharged. Program flow continues to step 606.

In step 606, the controller 320 is configured to stop and reset the TCA0 timer 361 and to clear the overflow interrupt flag (OVF) of the TCA0 timer 361. The controller 320 then starts TCA0 timer 361. Program flow continues to step 608.

In step 608, controller 320 is configured to determine whether a user interaction is occurring. If the user interaction is occurring, program flow continues to step 610. Otherwise, program flow continues to step 612.

In step 612, the controller 320 is configured to stop and reset the TCA0 timer 361, to clear the overflow interrupt flag (OVF) of the TCA0 timer 361, and to set the value of the minute_counter register 810 to 0, to set the value of the two_second register 812 to 0, and to set the value of the Op_State register to 0. Program flow returns to step 515 in FIG. 9A via ‘B’ 528.

The program flow from step 532 (FIG. 9B) via ‘A’ 548 to step 604 (FIG. 9D), and continuing through steps 606, step 608, and step 612, before returning to step 515 via ‘B’ 528, defines operation when the user interacts with the conductive pad 135 to discharge the accumulated charge 335 and reset the electrostatic discharge apparatus to the beginning of the time interval t1 701.

Interaction of the user with the conductive pad 135 in step 532 discharges any accumulated electrostatic charge 335 through the conductive pad 135, through the dissipative element 244, through the power ground 301, through the earth ground prong 406 and to the earth ground of the AC power socket.

In step 610, the controller 320 is configured to determine if the TCA0 timer 361 has timed out by checking the overflow interrupt flag (OVF) of the TCA0 timer 361. If the TCA0 timer 361 has not timed out program flow returns to step 608. Otherwise, program flow continues to step 614.

In step 614, the controller 320 is configured to stop and reset the TCA0 timer 361, to clear the overflow interrupt flag (OVF) of the TCA0 timer 361, and to cause a double tone beep. The TCA0 timer 361 is started. The double tone beep notifies the user of the beginning of the programming mode.

There are three programming modes (a first programming mode, a second programming mode, and a third programming mode) which sets the value of the t1 register 804.

In the first programming mode, the controller 320 is configured to set the value of the t1 register 804 equal to the value of the t1_default register 805.

In the second programming mode, the controller 320 is configured to set the value of the t1 register 804 equal to value listed in the table LUT1 based on the value of the RH_Level register 824.

In the third programming mode, the controller 320 is configured to permit the user to increment a value of the t1 register 804 from a starting value of 1 to a desired value. The user interaction of less than approximately 2 seconds increments the value of the t1 register 804 by one minute and successive user interactions of less than approximately 2 seconds will further increment the value of the t1 register 804 in one-minute increments.

The first programming mode comprises the program flow from step 532 (FIG. 9B), continuing to step 604 via ‘A’ 548 (FIG. 9D), continuing to step 606, continuing to step 608, continuing to step 610, continuing to step 614, continuing to step 616, continuing to step 618, continuing to step 620, continuing to step 622, and before returning to step 508 via ‘V’526.

In step 616, the controller 320 is configured to determine whether a user interaction is occurring. If the user interaction is occurring, program flow continues to step 618. Otherwise, program flow continues to step 628 via ‘D’626 in FIG. 9E.

In step 618 the controller 320 is configured to determine if the TCA0 timer 361 has timed out by checking the overflow interrupt flag (OVF) of the TCA0 timer 361. If the TCA0 timer 361 has not timed out program flow returns to step 616. Otherwise, program flow continues to step 620.

In step 620, the controller 320 is configured to stop and reset the TCA0 timer 361, to clear the overflow interrupt flag (OVF) of the TCA0 timer 361, to set the value of the t1 register 804 equal to the value of the t1_default register 805, to set the value of the Prog_Mode 802 register to 0, and to produce a long single tone beep indicating to the user that the value of the t1 register 804 has been set to the t1_default value and the programming mode has been completed. Program flow continues to step 622.

In step 622, the controller is configured to determine whether the user interaction is occurring. If user interaction is occurring, program flow returns to step 622. Otherwise, program flow returns to step 508 via ‘V’ 526 in FIG. 9A.

Thus, by simply maintaining user interaction from step 532 through to step 620 sets the value of the t1 register 804 equal to the value of the t1_default register 805 (which equals 3 minutes).

The second programming mode automatically programs the value of the t1 register 804 based upon the value of the RH_Level register 824 and sets the Prog_Mode 802 variable equal to 1.

The second programming mode comprises the program flow from step 532 (FIG. 9B) to step 604 via ‘A’ 548 in FIG. 9D, continuing to step 606, continuing to step 608, continuing to step 610, continuing to step 614, continuing to step 616, continuing to step 628 via ‘D’ 626 in FIG. 9E, continuing to step 630, continuing to step 632, continuing to step 634, continuing to step 636 before returning to step 508 in FIG. 9A via ‘V’ 526.

In step 628, the controller 320 is configured to stop and reset the TCA0 timer 361, to clear the overflow interrupt flag (OVF) of the TCA0 timer 361, and to start the TCA0 timer 361. Program flow continues to step 630.

In step 630, the controller 320 is configured to determine whether a user interaction is occurring. If the controller 320 determines a user interaction is occurring, program flow continues to step 638. Otherwise, program flow continues to step 632.

In step 632, the controller 320 is configured to determine whether the TCA0 timer 361 has timed out by checking the overflow interrupt flag (OVF) of the TCA0 timer 361. If the first timer 361 has not timed out program flow returns to step 630. Otherwise, program flow continues to step 634.

In step 634, the controller 320 is configured to cause the LED indicator 445a to emit a single red blink and to cause the TCB0 timer 362 to emit a long single tone beep. Program flow continues to step 636.

In step 636, the controller 320 is configured to stop and reset the TCA0 timer 361, to clear the overflow interrupt flag (OVF) of the TCA0 timer 361 and to set the value of the Prog_Mode register 802 to 1. Setting the value of the Prog_Mode register 802 to 1 indicates that the value of the t1 register 802 is set by the respective values listed in table LUT1 based on the value of the RH_Level register 824. Program flow returns to step 508 in FIG. 9A via ‘V’ 526.

In step 638, the controller 320 is configured to set the value of the t1 register 804 equal to 0. Program flow continues to step 640.

Program flow also continues from ‘G’ 648 to step 640.

In step 640, the controller 320 is configured to stop and reset the TCA0 timer 361, to clear the overflow interrupt flag (OVF) of the TCA0 timer 361, to increment the value of the t1 register 804 by 1, and to cause the TCB0 timer 362 to emit a single tone beep. Further, the controller 320 then starts the TCA0 timer 361. Program flow continues to step 642.

In step 642, controller 320 is configured to determine whether a user interaction is occurring. If a user interaction is occurring, program flow continues to step 644. Otherwise, program flow continues to step 650 in FIG. 9F via ‘F’ 649.

In step 644 the controller 320 is configured to determine if the TCA0 timer 361 has timed out by checking the overflow interrupt flag (OVF) of the TCA0 timer 361. If the TCA0 timer 361 has not timed out, program flow returns to step 642. Otherwise, program flow continues to step 646.

In step 646, the controller 320 is configured to stop and reset the TCA0 timer 361, to clear the overflow interrupt flag (OVF) of TCA0 timer 361, and to produce a long single tone beep. The Prog_Mode register 802 is also set to 0. Program flow continues to step 658.

In step 658, the controller 320 is configured to determine whether a user interaction is occurring. If a user interaction is occurring, program flow returns to step 658. Otherwise, program flow returns to step 508 in FIG. 9A via ‘V’ 526.

Referring now to FIG. 9F, program flow continues from step 642 in FIG. 9E via ‘F’ 649 to step 650 in FIG. 9F.

In step 650, the controller 320 is configured to stop and reset the TCA0 timer 361, to clear the timer overflow interrupt flag (OVF) of the TCA0 timer 361 and then to start the TCA0 timer 361. Program flow continues to step 652.

In step 652, controller 320 is configured to determine whether a user interaction is occurring. If the user interaction is occurring, program flow continues returns to step 640 in FIG. 9E via ‘G’ 648. Otherwise, program flow continues to step 654.

In step 654 the controller 320 is configured to determine if the TCA0 timer 361 has timed out by checking the overflow interrupt flag (OVF) of the TCA0 timer 361. If the TCA0 timer 361 has not timed out program flow returns to step 652. Otherwise, program flow continues to step 656.

In step 656, the controller 320 is configured to stop and reset the TCA0 timer 361, to clear the overflow interrupt flag (OVF) of the TCA0 timer 361, to turn-off the LED indicator 445a and to cause the TCB0 timer 362 to produce a long single tone beep alerting the user that the programming mode is complete. Program flow continues to step 660.

In step 660, the controller 320 is configured to set the value of the Prog_Mode register 802 to 0. Program flow then returns to step 508 in FIG. 9A via ‘V’ 526.

The third programming mode allows the user to manually set the value of for the t1 register 804 based upon the number of user interactions occurring for approximately less than two seconds.

Referring to FIG. 13, a timing diagram of the three operational states of the electrostatic discharge apparatus 10 is shown and comprises the first operational state having a time interval t1 701, the second operational state having a time interval t2 702, and the third operational state having an indefinite time interval t3 703.

The time interval t1 701 equals the value of the t1 register 804 in minutes. The time interval t2 702 equals the value of the t2 register 808 in minutes. The time interval t3 703 continues indefinitely until a user interaction occurs. It is understood that a user interaction can occur at any time, and a user interaction returns the program flow to step 515 and the beginning of the time interval t1 701, unless the user initiates one of the three programming modes.

For the time interval t1 701, the controller 320 is configured to cause the LED indicator 445a to emit a single green blink and to also cause the LED indicator 445b to emit a single or double blink in a color corresponding to the value of the RH_Level register 824 substantially every two seconds in step 522.

The time interval t1 701 continues until the value of the minute_counter register 810 equals the value of the t1 register 802 in step 542. When the value of the minute_counter register 810 equals the value of the t1 register 804, the program flow branches to step 546 setting the Op_State register 809 to 1.

At the end of the time interval t1 701, the controller 320 is configured to generate a response to cause the LED indicator 445a to emit a single amber blink and to also cause the LED indicator 445b to emit a single or double blink in a color corresponding to the value of the RH_Level register 824 substantially every two seconds in step 524. A single tone beep may also be sounded depending upon the position of the sound selector switch 180.

Thus, after the time delay defined by the time interval t1 701 the controller 320 is configured to generate the time-delayed response defined by the beginning of the time interval t2 702.

The time interval t2 702 continues until the value of the minute_counter register 810 equals the sum of the values of the t1 register 802 and the t2 register 808 in step 544. When the value of the minute_counter register 810 equals the sum of the values of the t1 register 802 and the t2 register 808, the program flow branches to step 552 and enters the time interval t3 703.

For the time interval t3 703, the controller is configured to cause the LED indicator 445a to emit a constant red illumination and also to cause the LED indicator 445b to emit a constant illumination in a color corresponding to the value of the RH_Level register 824. A single tone beep may also be sounded depending upon the position of the sound selector switch 180.

It is therefore understood that the controller 320 is responsive to the sensor 275 and is configured to generate the time-delayed response. The time interval t1 701 defines the time delay. Upon the expiration of the time interval t1 701, the controller 320 is configured to generate a response that causes the LED indicator 445a to emit an amber blink at approximately two-second intervals during the time interval t2 702 and a constant red illumination during the time interval t3 703. During the t2 and t3 time intervals, the time-delayed response may also selectively cause the audible indicator 146 to beep.

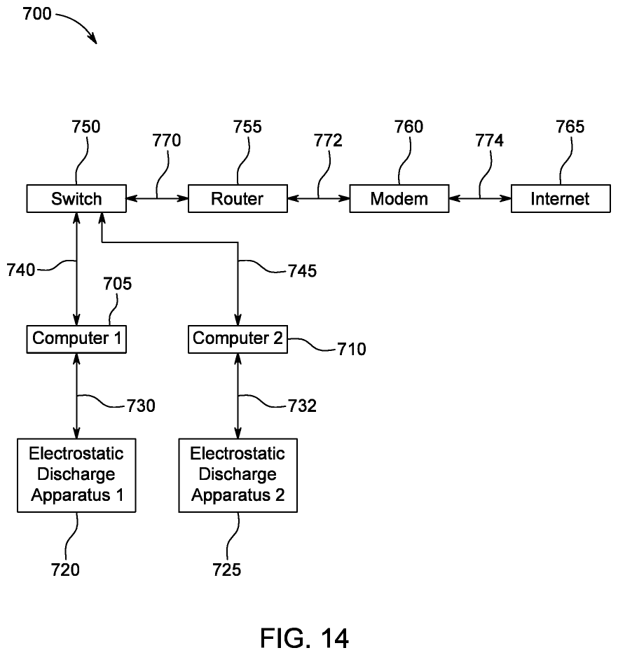

Referring now to FIG. 14, an electrostatic discharge and monitoring network 700 is shown. The electrostatic discharge and monitoring network comprises, for example but not limited to, a computer 705 and a computer 710, one or more electrostatic discharge apparatuses 720 and 725, a network switch 750, an internet router 755, and an internet modem 760.

The electrostatic discharge apparatuses 720 and 725 are connected to computers 705 and 710 via the USB cables 730 and 732, respectively.

Each computer 705 and 710 may be hard-wired connected to a network switch 750 via ethernet cables 740 and 745, respectively, or may be wirelessly connected using, for example, Wi-Fi (not shown). The computers 705 and 710 along with the network switch 750 may form a local area network (LAN). The number of computers connected to the LAN may be expanded and may consist of a combination of wired and wirelessly connected computers.

The network switch 750 is connected to the internet router 755 via a communication channel 770. The internet router 755 is connected to the internet modem 760 via communication channel 772. The internet modem 760 is connected to an internet service prover (ISP) 765 via communication channel 774 which may be a coax cable. The internet ISP 765 provides internet access for each computer 705 and 710.

The network 700 is configured to provide data communication among the networked computers 705 and 710 and the internet 765.

The data which may be sent and received among the LAN devices and the internet 765 may comprise the relative humidity and the temperature data, the frequency of user interaction data, the t1 register data, the t2 register value, the Op_State register data, and other data.

I claim:

1. An electrostatic discharge apparatus comprising:
a conductor configured for interaction with a user;
a ground connection;
a dissipative element electrically coupled between the conductor and the ground connection;
a first sensor configured to detect the user interaction with the conductor;
a controller responsive to the first sensor and configured to generate a time-delayed response based on the detected interaction; and
an indicator responsive to the time-delayed response to prompt discharge of electrostatic charge through the conductor.

2. An electrostatic discharge apparatus according to claim 1 wherein the conductor comprises a conductive pad etched into a printed circuit board.

3. An electrostatic discharge apparatus according to claim 1 wherein the dissipative element comprises a resistor.

4. An electrostatic discharge apparatus according to claim 1 wherein the first sensor comprises:
an electromagnetic radiator configured to provide electromagnetic radiation;
a first optical element coupled to the electromagnetic radiator and configured to produce a thin, narrow sheet of directed electromagnetic radiation along an optical path across and adjacent to the surface of the conductor;
a second optical element configured to receive the directed electromagnetic radiation adjacent to the surface of the conductor along the optical path; and
an electromagnetic detector coupled to the second optical element and responsive to the electromagnetic radiation.

5. An electrostatic discharge apparatus according to claim 1 wherein the controller is configured to generate a time interval for the time-delayed response based on a number of detected interactions.

6. An electrostatic discharge apparatus according to claim 1 further comprising:
a second sensor configured to sense relative humidity, wherein the controller is responsive to the second sensor and configured to generate a time interval of the time-delayed response based on the sensed relative humidity.

7. An electrostatic discharge apparatus according to claim 1 further comprising:
a power source for providing direct current power with respect to earth ground; and
an indicator responsive to the direct current power.

8. An electrostatic discharge apparatus according to claim 1 wherein the indicator comprises an audible indicator.

9. An electrostatic discharge apparatus according to claim 1 wherein the indicator comprises a light emitting diode.

10. An electrostatic discharge switch comprising:
a conductor configured for interaction with a user;
a ground connection;
a dissipative element electrically coupled between the conductor and the ground connection;
a sensor configured to detect the interaction with the conductor; and
a controller responsive to the sensor and configured to perform a switching function.

11. An electrostatic discharge switch according to claim 10 wherein the sensor comprises:
an electromagnetic radiator configured to provide electromagnetic radiation;
a first optical element coupled to the electromagnetic radiator and configured to produce a thin, narrow sheet of directed electromagnetic radiation along an optical path across and adjacent to the surface of the conductor;
a second optical element configured to receive the directed electromagnetic radiation adjacent to the surface of the conductor along the optical path; and
an electromagnetic detector coupled to the second optical element and responsive to the electromagnetic radiation.

12. An electrostatic discharge and monitoring system comprising:
an electrostatic discharge apparatus;
a computer coupled to the electrostatic discharge apparatus; and
a computer network coupled to the computer.
